(19) United States
(12) Patent Application Publication
(10) Pub. No.: US 2021/0192549 A1
(43) Pub. Date: Jun. 24, 2021

(54) GENERATING ANALYTICS TOOLS USING A PERSONALIZED MARKET SHARE

(71) Applicant: Adobe Inc., San Jose, CA (US)

(72) Inventors: Atanu R. Sinha, Bangalore (IN); Paridhi Maheshwari, Bhopal (IN); Ayalur Vedpuriswar Lakshmy, Hyderabad (IN); Tanay Anand, Sonebhadra (IN); Vishal Manohar Jain, Surat (IN)

(21) Appl. No.: 16/722,626

(22) Filed: Dec. 20, 2019

(51) Int. Cl. G06Q 30/02

(52) U.S. Cl. CPC G06Q 30/0204; G06Q 30/0201

(57) ABSTRACT

Systems, methods, and non-transitory computer-readable media are disclosed for easily, accurately, and efficiently determining a personalized market share of a user with a company versus that of its competitors using only focal company's own clickstream data. For instance, the disclosed systems can infer a mapping of purchases to product categories from clickstream data of a company and use the mappings to generate a dataset of observable conversions (with interconversion times) for one or more product categories. Then, the disclosed systems can utilize models for a category level interconversion time and for transition probabilities of a user to determine a personalized market share and an interconversion time for an individual user (between the company and competitors of the company). In addition, the disclosed systems can generate graphical user interfaces that efficiently provide personalized customer statistics based at least on the determined personalized market share and interconversion times for the individual user.

### BACKGROUND

Recent years have seen a rapid increase in the utilization of digital analytics tools. Indeed, businesses increasingly utilize digital analytics tools that determine and provide customer journey analytics. For instance, conventional analytics tools often utilize data that is accessible to a business to characterize journey analytics for customers of the business. Although conventional analytics tools determine and provide customer metrics, they also have a number of significant shortcomings, particularly in regard to easily, accurately, and efficiently determining and providing such metrics for potential upside of customers for a business.

For example, many conventional analytics tools cannot determine a complete analytics picture for customers of a business due to a lack of data for the customers' with competitors and other businesses. As such, conventional analytics tools cannot determine if a customer has made purchases from a competitor or the true business potential of the customer due to the ability to only determine a partial view of the customer's interactions.

Furthermore, many conventional analytics tools are also inaccurate. In particular, conventional analytics tools often fail to determine and provide accurate customer metrics partly because of an inability to determine and provide meaningful user metrics without a significant amount of customer data and/or without access to customer data from competitors of the business. Indeed, in many conventional analytics tools, the determined customer metrics are often incomplete due to a lack of customer data (e.g., no access to competitor data) and, therefore, result in incomplete evaluations. Such evaluations often do not provide accurate and/or meaningful customer metrics.

As a result of the above mentioned inflexibility and lack of accuracy, conventional analytics tools are also often inefficient. In particular, many conventional analytics tools fail to efficiently provide functions and/or information corresponding to customers in relation to a business. For instance, many conventional analytics tools often utilize significant amounts of computing resources to provide customer metrics (or behavioral predictions) that are determined from processing large amounts of data but still fail to account for customer data that is inaccessible to the business. Thus, such conventional analytic tools often require additional customer data and/or hand crafting of available data (which may require additional processing, navigational steps within a user interface, and/or data storage) prior to being able to provide meaningful customer metrics and/or functionalities related to the customer metrics.

### SUMMARY

This disclosure describes one or more embodiments that provide benefits with systems, computer-readable media, and methods that can easily, accurately, and efficiently determine a personalized market share of a user with a company versus that of its competitors. In particular, the disclosed systems can utilize clickstream data to determine a personalized market share and an interconversion time at an individual user level that accounts for a company and competitors without reliance on user interaction data from the competitors. For instance, the disclosed systems can infer a mapping of purchases to product categories from clickstream data of a company and use the mappings to identify observable conversions of users and/or user-specific features in relation to the one or more product categories. Subsequently, the disclosed systems can determine a personalized market share and an interconversion time for an individual user utilizing parameters estimated using the observable conversions. As such, one or more embodiments can provide a complete picture of a customer's journey despite not having accesses to competitor data. Moreover, the disclosed systems can generate graphical user interfaces that efficiently provide personalized customer statistics based at least on the determined personalized market share and interconversion times for the individual user.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

The detailed description is described with reference to the accompanying drawings briefly described below.

FIG. 1 illustrates a schematic diagram of an example system in which a digital personalized-market-share determination system can operate in accordance with one or more embodiments.

FIG. 2 illustrates an overview of a process of a digital personalized-market-share determination system determining a personalized market share using clickstream data in accordance with one or more embodiments.

FIG. 3 illustrates a schematic diagram of a digital personalized-market-share determination system inferring observable conversions within product categories using clickstream data in accordance with one or more embodiments.

FIG. 4A illustrates a schematic diagram of a digital personalized-market-share determination system determining a personalized market share and an interconversion time in accordance with one or more embodiments.

FIG. 4B illustrates a purchase transition probability diagram in accordance with one or more embodiments.

FIGS. 5A-5C illustrate graphical user interfaces generated by a digital personalized-market-share determination system to display personalized customer statistics in accordance with one or more embodiments.

FIGS. 6A-6B illustrate graphical user interfaces generated by a digital personalized-market-share determination system to display identified target users based on personalized market shares in accordance with one or more embodiments.

FIG. 7 illustrates an example architecture of a digital personalized-market-share determination system in accordance with one or more embodiments.

FIG. 8 illustrates a flowchart of a series of acts for determining a personalized market share of a user with a company versus that of competitors using clickstream data in accordance with one or more embodiments.

FIG. 9 illustrates a block diagram of an example computing device in accordance with one or more embodiments.

### DETAILED DESCRIPTION

One or more embodiments of the present disclosure include a digital personalized-market-share determination system that can determine a personalized market share (and an interconversion time) for an individual user between a focal company and competitors of the company using clickstream data from the focal company. In particular, the digital personalized-market-share determination system can infer observable conversions within a product category from clickstream data of an individual user (e.g., from a website of a focal company). Subsequently, the digital personalized-market-share determination system can determine a personalized market share and/or interconversion time of the individual user between the company and competitors of the company for the product category based on the observable conversions in the focal company's data. Indeed, in some embodiments, the digital personalized-market-share determination system can determine such information without utilizing user interaction data for the individual user from competitors of the company. Additionally, the digital personalized-market-share determination system can generate one or more improved graphical user interfaces that efficiently provide functions and/or information relating to personalized customer statistics that are based on the personalized market share and/or interconversion time determined using clickstream data of the individual user.

As just mentioned, the digital personalized-market-share determination system can infer one or more observable conversions in a product category for an individual user from clickstream data. In particular, the digital personalized-market-share determination system can infer a mapping of identities (IDs) (or conversion interactions) to product categories in order to build a category-level model from clickstream data. Then, the digital personalized-market-share determination system can utilize the clickstream data and the ID mappings to identify conversions, conversion times, and conversion categories for individual users. Indeed, the digital personalized-market-share determination system can convert hit-level data (from the clickstream data) into product-category-specific datasets that include observable conversions for individual users for the specific product categories.

Moreover, the digital personalized-market-share determination system can determine a personalized market share (and/or an interconversion time) for the individual user between a company and competitors of the company. More specifically, the digital personalized-market-share determination system can utilize the dataset of observable conversions of individual users (and/or other user data) obtained from the clickstream data to estimate one or more conversion probability parameters and scale parameters for the individual users. For example, the digital personalized-market-share determination system 106 can utilize a Hierarchical Bayes and Markov Chain Monte Carlo approach. Furthermore, the digital personalized-market-share determination system can determine the personalized market share for the individual user by using the estimate conversion probability parameters in combination with a model for transition probabilities of the individual user between the company and competitors of the company (e.g., based on a Markov Chain). Moreover, the digital personalized-market-share determination system can also determine an interconversion time for the individual user across the company and the competitors of the company using the estimate conversion probability parameters and a scale parameter for the individual user (e.g., using the personalized market share of the individual user and an interconversion time model based on an Erlang-2 distribution).

In addition, the digital personalized-market-share determination system can also generate graphical user interfaces to display personalized customer statistics for the individual user based on the personalized market share (and/or interconversion time). For instance, the digital personalized-market-share determination system can generate a graphical user interface to display personalized market shares of multiple users for a product category (e.g., to facilitate an easily accessible comparison of trends of personalized market share amongst the individual users). Additionally, the digital personalized-market-share determination system can also identify and indicate target users (e.g., users that can be targeted to as potential lead opportunities) within generated graphical user interfaces based on the personalized market share and interconversion time data. Indeed, the digital personalized-market-share determination system can generate graphical user interfaces that display and provide accurate and individualized user information (e.g., personalized customer statistics) within analytics tools with less navigational steps and less input data complexity.

The digital personalized-market-share determination system of one or more implementations of the present disclosure provides advantages and benefits over conventional systems and methods by easily, accurately, and efficiently determining a personalized market share of a user with a company versus that of its competitors using focal company clickstream data and generating graphical user interfaces based on the personalized market share. For example, the digital personalized-market-share determination system can determine a personalized market share of a user with a company versus that of its competitors using clickstream data from the company without relying on data that is inaccessible to the company (e.g., a competitor's data). Accordingly, the digital personalized-market-share determination system can determine and provide meaningful user metrics (e.g., the personalized market share and/or interconversion time) with more flexibility. Moreover, by utilizing clickstream data, the digital personalized-market-share determination system is able to provide such meaningful user metrics at an individual user level (rather than as an aggregate evaluation or an evaluation of an average user). In addition, by utilizing clickstream data, the digital personalized-market-share determination system can determine a personalized market share for individual users and provide analytics tools with such information with a lesser amount and complexity of data (e.g., less administrator hand crafting of data).

In addition to an improvement in flexibility, the digital personalized-market-share determination system can also improve accuracy. For instance, by determining a personalized-market-share that accounts for possible interactions of a user with competitors, the digital personalized-market-share determination system provides a more accurate (and complete) evaluation for an individual user's engagement between a company and competitors of the company. Accordingly, the digital personalized-market-share determination system provides more accurate and meaningful user metrics (at an individual user level) compared to many conventional analytics tools.

Additionally, the digital personalized-market-share determination system can also improve efficiency. For example, the digital personalized-market-share determination system can more efficiently utilize computing resources by providing accurate and meaningful user metrics (e.g., a personalized market share for a user) while utilizing less data. For example, the digital personalized-market-share determination system is able to accurately determine personalized market shares and/or interconversion times for individual users with incomplete data while causing an estimation model to converge more quickly in comparison to conventional analytics tools (e.g., with less computational time and processing).

Furthermore, the digital personalized-market-share determination system also generates improved graphical user interfaces for analytics tools that increases analytics functionality while reducing the time and number of user interactions required to access such functionality or information. For instance, the digital personalized-market-share determination system can generate graphical user interfaces that automatically provide personalized market share trends for individual users, identify target users, and/or provide a customer journey of a user with personalized market share data by using clickstream data of a company with fewer user interactions (e.g., fewer steps) and less required navigation between different user interfaces or applications. Additionally, the digital personalized-market-share determination system can generate graphical user interfaces that provide functionality to access personalized market share data of an individual user across separate product categories of company primarily from clickstream data.

As illustrated by the foregoing discussion, the present disclosure utilizes a variety of terms to describe features and advantages of the digital personalized-market-share determination system. Additional detail is now provided regarding the meaning of such terms. For example, as used herein, the term “observable conversion” refers to information (or interactions) of a user available to an observing company that indicates a conversion. A user can perform a conversion when he or she purchases a product or service (for ease of explanation, the term product hereafter refers to both products and services and includes subscriptions, bundles, and on-demand/one-time purchasable products). In some embodiments, conversions include non-purchases, such as when a user performs a specified action (e.g., signs up for a free-trial or update, downloads an application or software, or performs membership registration). In particular, the term “observable conversion” can refer to information that indicates a conversion corresponding to a company that is accessible to the company.

Moreover, as used herein, the term “clickstream data” (sometimes referred to as “hit-level data” or “click path data”) refers to information corresponding to one or more user interactions from one or more users on a digital platform. In particular, the term “clickstream data” can refer to an informational record of user interactions (e.g., behavior logs) that indicate various combinations of navigational and purchase behaviors of one or more users on a website (or digital application) corresponding to a company. For example, clickstream data can include information such as, but not limited to, hit-level interactions and/or purchase or conversion interactions. For instance, hit-level interactions can include, but are not limited to, website and/or application navigation (e.g., one or more sequences of hyperlink paths for website pages), interactions with media or objects on a website or application, a time of occurrence, time spent on a web page, user identifiers, device identifiers, and/or IP addresses. Moreover, a purchase or conversion interaction can include, but is not limited to, a hit-level interaction indicating a payment, download, an information submission corresponding to a service or subscription, and/or identifiers corresponding to the purchase (e.g., confirmation number, purchase ID, purchase amount, payment method). In summary, a clickstream data point refers to a point of contact between a user and a commercial entity (e.g., a business or company), which can occur via an electronic trackable channel such as email, social media, organic search, pay-for-click, via website, via a native computing application, etc.

As used herein, the term “product category” (or sometimes referred to as “category”) refers to a grouping or classification of one or more products (and/or services). In particular, the term “product category” can refer to a classification that describes a set of products (and/or services) having a relationship that is identified from attributes of products (and/or services) or is configured by an administrator of a company. For example, a product category can include, but is not limited to, electronics, clothing, appliances, books, video games, movies, and music. Additionally, a product category can also include, but is not limited to, televisions, computers, phones, gaming consoles, and smart watches (e.g., specific types of electronics).

As used herein, the term “company” refers to any entity that operates and/or owns a business that provides products and/or services. In particular, the term “company” refers to an entity that sell products and/or provide services and/or subscriptions via a digital platform such as a website and/or an application. For example, a company can include, but is not limited to, a department store, an electronics store, an e-commerce provider, an online streaming provider, a music streaming provider, a cell phone service provider, and/or a software provider. Moreover, as used herein, the term “competitor” (sometimes referred to as “competitor of a company”) refers to any entity that operates and/or owns a business that provides similar products and/or similar services to a company but does not share all available user (or customer) data with the company.

As used herein, the term “personalized market share” refers to information or metrics corresponding to an individual user's engagement between a company and one or more competitors of the company. In particular, the term “personalized market share” refers to an individual user's engagement associated with a company versus one or more competitors of the company in terms of share of wallet, spending, and/or time. For example, a personalized market share can include a percentage corresponding to an individual user's utilization of a company versus that of competitors of the company. As used herein, the term “share of wallet value” can refer to an amount of spending that users (or customers) provide to a particular company in comparison to competitors of the company.

As used herein, the term “estimate conversion probability” (or sometimes referred to as “conversion probability”) refers to a value that represents the likelihood of a user utilizing a company for a purchase related interaction. In particular, the term “estimate conversion probability” can refer to a probability associated with a user's transition (in terms of a conversion interaction) on a company to a competitor and/or from a competitor to the company. For example, a conversion probability can include the probability that a user that has made a conversion (e.g., purchase) corresponding to a company will return to the company for the next conversion. Additionally, a conversion probability can include the probability that a user that has made a conversion corresponding to a competitor of a company will go to the company for their next conversion.

Furthermore, as used herein, the term “multivariate normal distribution” refers to a generalization of a one dimensional normal distribution to higher dimensions. In particular, a multivariate normal distribution can be utilized to approximately describe any set of possibly correlated random variables. For example, a multivariate normal distribution can be utilized to determine conversion probabilities and/or a personalized market share in accordance with one or more embodiments herein.

As used herein, the term “interconversion time value” (sometimes referred to as “interconversion time”) refers to a time elapsed between conversion interactions of a user (e.g., time between purchases). In particular, the term “interconversion time value” can refer to a time elapsed between conversion interactions of an individual user across conversions corresponding to a company and competitors of the company. For instance, an interconversion time value can include a number of minutes, hours, days, and/or weeks between conversion interactions of a user across purchases corresponding to a company and competitors of the company (e.g., successive purchases by a user). In particular, an interconversion time can include a time elapsed between observed and/or unobserved conversion of an individual user (across a company and competitors of the company).

As used herein, the term “interconversion time model” refers to a distribution utilized to model interconversion times for one or more users. In particular, the term “interconversion time model” can refer to a Gamma distribution utilized to model interconversion times for one or more users using observable conversions of a company. For example, an interconversion time model can include a model created using an Erlang-2 distribution and/or an Erlang-5 distribution.

As used herein, the term “target user” refers to a user that is indicated to be of interest to a company. In particular, the term “target user” refers to a user that is indicated to be of interest as a lead and/or opportunity to a company and/or as a user that may have a potential in increasing market share in association with a company. For example, a target user can include a user that frequently purchases a type of product but has a low personalized market share at a company such that a company can market to raise the personalized market share (as described in greater detail below).

As used herein, the term “personalized customer statistic” refers to information or metrics stemming from various combinations of an observable conversion, a determined personalized market share, and/or interconversion time for an individual user. For example, a personalized customer statistic can include customer journey information (e.g., a history of purchases for an individual user) with information related to a personalized market share and/or interconversion time for an individual user (e.g., trends). Moreover, a personalized customer statistic can include indications of whether a user is a target user and/or information corresponding to how often a user purchases products from a competitor versus a focal company.

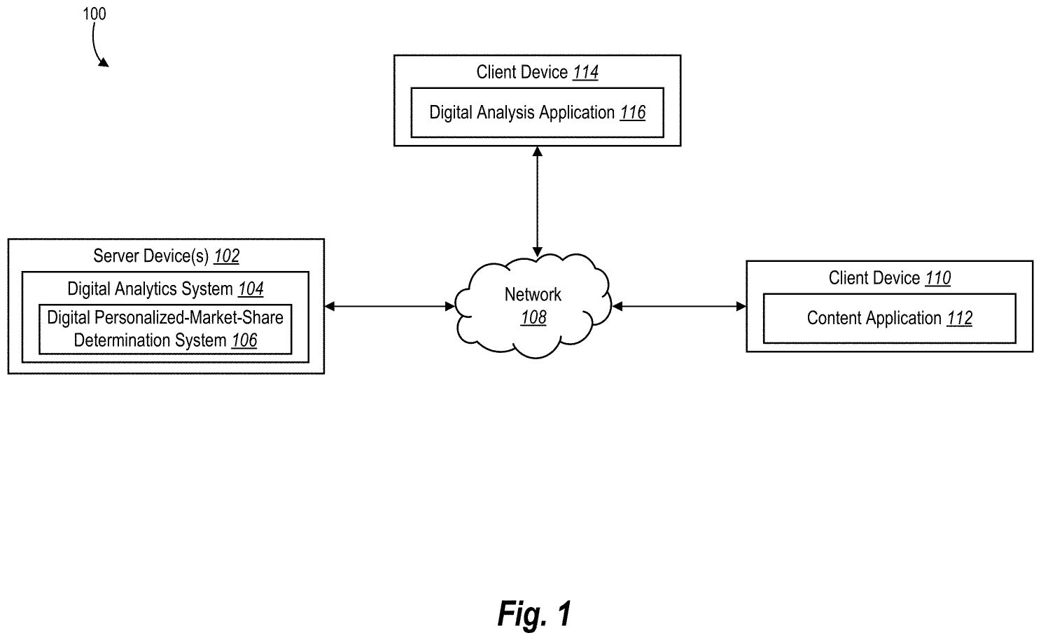

Turning now to the figures, FIG. 1 illustrates a schematic diagram of a system 100 in which a digital personalized-market-share determination system 106 can operate in accordance with one or more embodiments. As illustrated in FIG. 1, the system 100 includes server device(s) 102, a network 108, a client device 110, and a client device 114. As further illustrated in FIG. 1, the one or more components of the system 100 can communicate with each other (e.g., via the network 108).

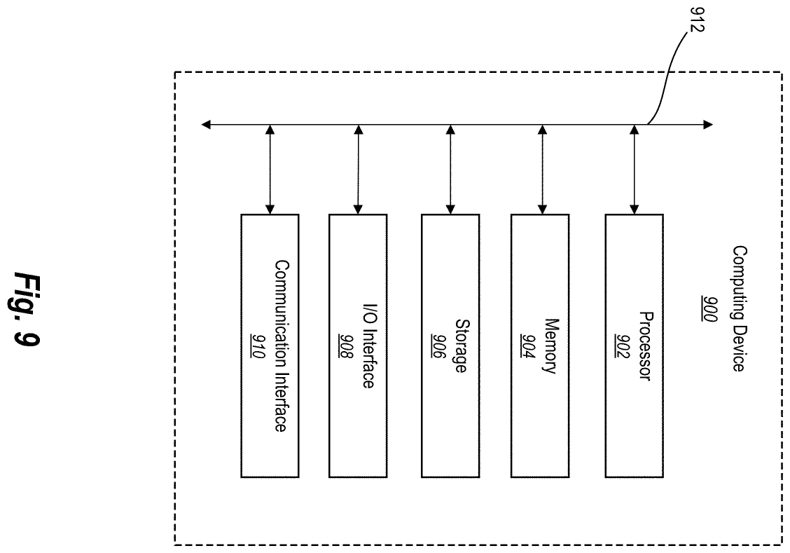

As shown in FIG. 1, the server device(s) 102 can include a variety of types of computing devices, including those explained with reference to FIG. 9. The server device(s) 102 can include a digital analytics system 104 which further includes the digital personalized-market-share determination system 106. The digital analytics system 104 can store, process, receive, utilize, manage, and/or provide user data (e.g., clickstream data), analytics data (e.g., analytics data generated by the digital personalized-market-share determination system 106 and/or aggregate analytics data available via a third party), and/or analytics tools (e.g., analytics tools generated by the digital personalized-market-share determination system 106 and/or a third party).

For example, the digital analytics system 104 tracks user data in various ways. In one or more embodiments, the digital analytics system 104 tracks the user data and then reports the tracked user data to the digital personalized-market-share determination system 106 as clickstream data. Alternatively, the digital analytics system 104 receives tracked user data directly from the client device 110. In particular, the digital analytics system 104 may receive information through data stored on a client device (e.g., a browser cookie, cached memory), embedded computer code (e.g., tracking pixels), a user profile, or engage in any other type of tracking technique. Accordingly, the digital analytics system 104 can receive tracked user data from a third-party network server(s) and/or directly from client devices, such as client device 110.

For instance, the digital analytic system 104 can track and record interaction or click data that includes, but is not limited to, data requests (e.g., URL requests, link clicks), impressions, time data (e.g., a time stamp for clicking a link, a time duration for a web browser accessing a webpage, a time stamp for closing an application), path tracking data (e.g., data representing webpages a user visits during a given session or visit), demographic data (e.g., an indicated age, sex, or socioeconomic status of a user), geographic data (e.g., a physical address, IP address, GPS data), downloads, account logins, media plays, purchases, adding items to an virtual shopping cart, abandoned virtual shopping carts, other transaction data (e.g., order history, email receipts), etc.

Additionally, the digital personalized-market-share determination system 106 can also generate graphical user interfaces (for analytics tools) based on personalized market shares and/or interconversion times determined using the clickstream data. Indeed, the digital personalized-market-share determination system 106 can provide identified observable conversions, user metrics such as a personalized market share, and graphical user interfaces generated based on such user metrics to one or more client devices corresponding to the company (e.g., the client device 114).

As shown in FIG. 1, the system 100 can include the client device 114. The client device 114 can modify, create, receive, and/or provide user data such as clickstream data, analytics data, and/or configurations to the digital personalized-market-share determination system 106 (via the server device(s) 102). In particular, the client device 114 can include a computing device that operates a digital analysis application 116. For instance, the digital analysis application 116 can provide analytics tools and graphical user interfaces generated by the digital personalized-market-share determination system 106 (e.g., to provide personalized customer statistics). Moreover, the digital analysis application 116 can provide options to send or retrieve data and/or options to configure the digital personalized-market-share determination system 106. For instance, the digital analysis application 116 can be a software application (e.g., that implements the digital personalized-market-share determination system 106) or a software application hosted on the server device(s) 102. For example, when hosted on the server device(s) 102, the digital analysis application 116 can be accessed by the client device 114 through a web browser.

Furthermore, as illustrated in FIG. 1, the system 100 can include the client device 110. Indeed, the client device 110 (e.g., a client device operated by a user) can access and interact with one or more websites and/or applications belonging to a company associated with the client device 114. In particular, the client device 110 can interact with one or more websites and/or applications belonging to the company to create user data such as clickstream data (e.g., via conversion interactions, hit-level interactions, sending or submitting information). As an example, the client device 110 can be operated by a customer of the company associated with the client device 114. Moreover, the client device 110, as illustrated in FIG. 1, can include a variety of types of computing devices, including those explained below with reference to FIG. 9.

Additionally, the client device 110 can include a content application 112. For example, the content application 112 can provide tools, graphical user interfaces, and/or options to send information and/or interact with one or more websites and/or digital applications belonging to the company associated with the client device 114 (or the digital personalized-market-share determination system 106). For example, the content application 112 can be a software application installed on the client device 110 or a software application hosted on one or more websites or server devices of the company. For example, the content application 112 can be accessed by the client device 110 through a web browser or a digital application and provide user interactions with a website and/or digital application that can be tracked/captured by the digital analytics system 104 as clickstream data.

Although FIG. 1 illustrates the system 100 with the client device 110 and the client device 114, in one or more embodiments, the system 100 can include additional client devices. For instance, the system 100 can include any number of client devices corresponding to users that interact with websites and/or digital applications of one or more companies. Furthermore, the system 100 can include any number of client devices corresponding to one or more companies that provide user data to the digital personalized-market-share determination system 106 and receive user metrics from the digital personalized-market-share determination system 106.

Furthermore, although FIG. 1 illustrates the digital personalized-market-share determination system 106 implemented on the server device(s) 102, the digital personalized-market-share determination system 106 can be implemented on the client device 114. In particular, the digital personalized-market-share determination system 106 can operate on the client device 114 and utilize user data collected by the client device 114 to determine metrics such as a personalized market share for users (e.g., customers) communicating with one or more websites and/or digital applications hosted by the client device 114. Indeed, in one or more embodiments, the digital personalized-market-share determination system 106 can be implemented on the digital analysis application 116.

Additionally, as shown in FIG. 1, the system 100 includes the network 108. As mentioned above, the network 108 can enable communication between components of the system 100. In one or more embodiments, the network 108 may include a suitable network and may communicate using any communications platform and technology suitable for transporting data and/or communication signals, examples of which are described with reference to FIG. 9. Furthermore, although FIG. 1 illustrates the server device(s) 102, the client device 114, and the client device 110 communicating via the network 108, the various components of the system 100 can communicate and/or interact via other methods (e.g., the server device(s) 102 and the client device 114 can communicate directly).

In addition, as previously mentioned, although FIG. 1 illustrates the digital personalized-market-share determination system 106 being implemented by a particular component and/or device (e.g., server device(s) 102) within the system 100, the digital personalized-market-share determination system 106 (and/or the digital analytics system 104) can be implemented, in whole or in part, by other computing devices and/or components in the system 100. For example, as mentioned above, the digital personalized-market-share determination system 106 (and/or the digital analytics system 104) can be implemented in whole, or in part, by the client device 114.

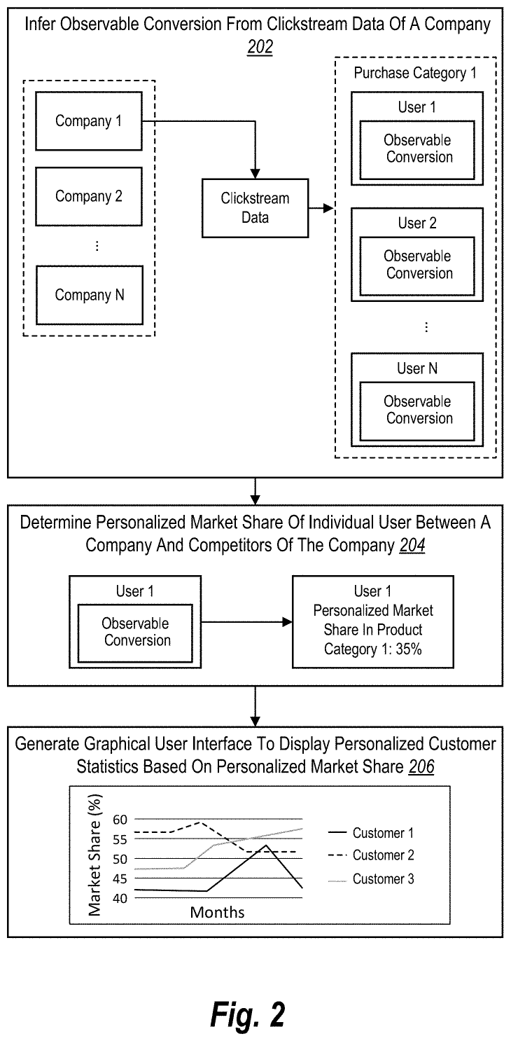

As mentioned above, the digital personalized-market-share determination system 106 can infer observable conversions for an individual user from clickstream data of a company, determine a personalized market share for the individual user between the company and competitors of the company, and generate graphical user interfaces for analytics tools based on the personalized market share. For instance, FIG. 2 illustrates a flowchart of the digital personalized-market-share determination system 106 determining a personalized market share for an individual user from clickstream data and generating graphical user interfaces based on the personalized market share data. More specifically, FIG. 2 illustrates a flowchart of the digital personalized-market-share determination system 106 inferring observable conversions for an individual user from clickstream data of a company, determining a personalized market share for the individual user between the company and competitors of the company, and generating graphical user interfaces for analytics tools based on the personalized market share.

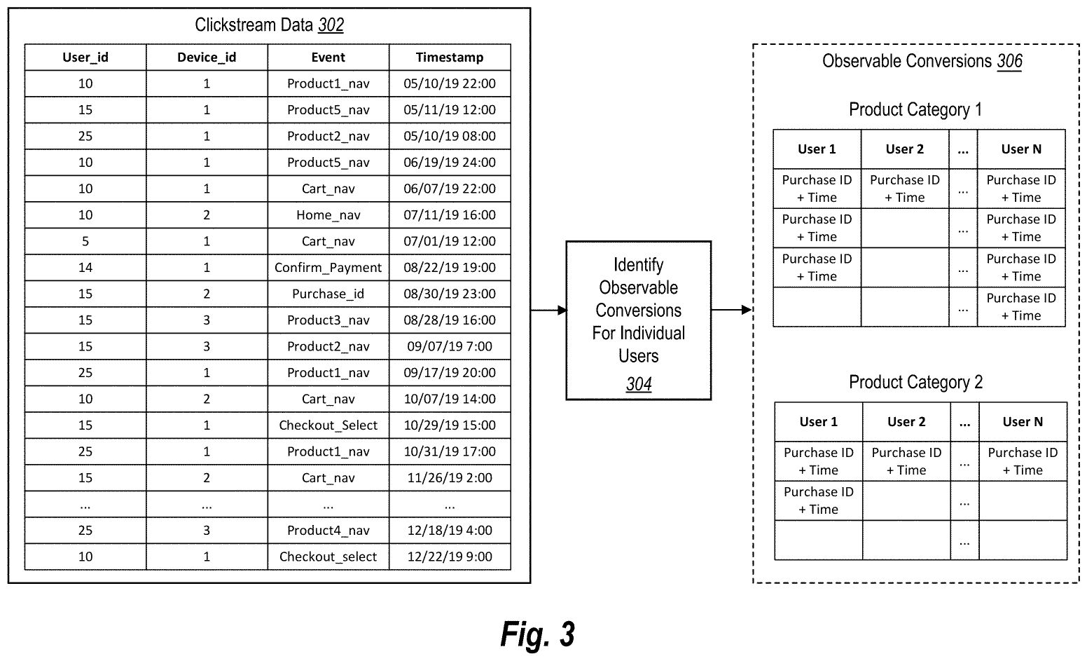

For instance, as shown in FIG. 2, the digital personalized-market-share determination system 106 performs an act 202 of inferring observable conversions from clickstream data of a company. For example, as illustrated in FIG. 2, the digital personalized-market-share determination system 106 can receive clickstream data from company 1 and infer observable conversions for multiple users and identify a corresponding product category for the observable conversions from the clickstream data. Additional detail regarding the digital personalized-market-share determination system 106 inferring observable conversions within a product category (for an individual user) from clickstream data is provided below (e.g., in relation to FIG. 3).

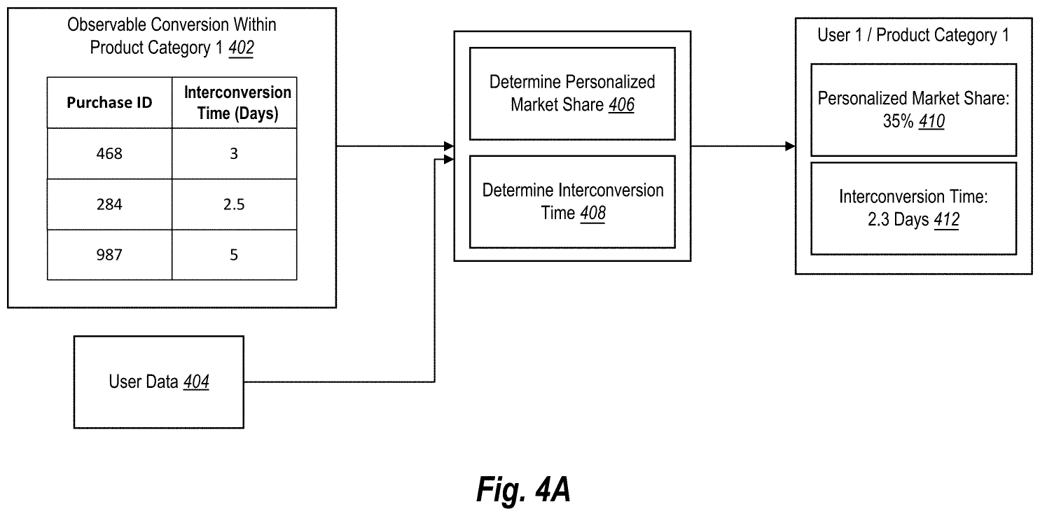

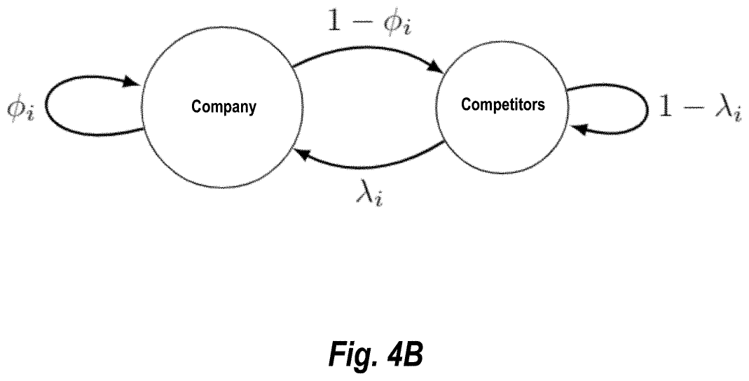

Furthermore, as illustrated in FIG. 2, the digital personalized-market-share determination system 106 performs an act 204 of determining a personalized market share of an individual user between a company and competitors of the company. For example, as shown in FIG. 2, the digital personalized-market-share determination system 106 can utilize the observable conversions of a user to determine a personalized market share for the individual user within a specific product category. Indeed, the digital personalized-market-share determination system 106 can determine the personalized market share (and/or interconversion time) of the user using the clickstream data for the company and without using user interaction data from competitors of the company (e.g., company 2, . . . , company n). Additional detail regarding the digital personalized-market-share determination system 106 determining a personalized market share (and/or interconversion time) using clickstream data is provided below (e.g., in relation to FIGS. 4A and 4B).

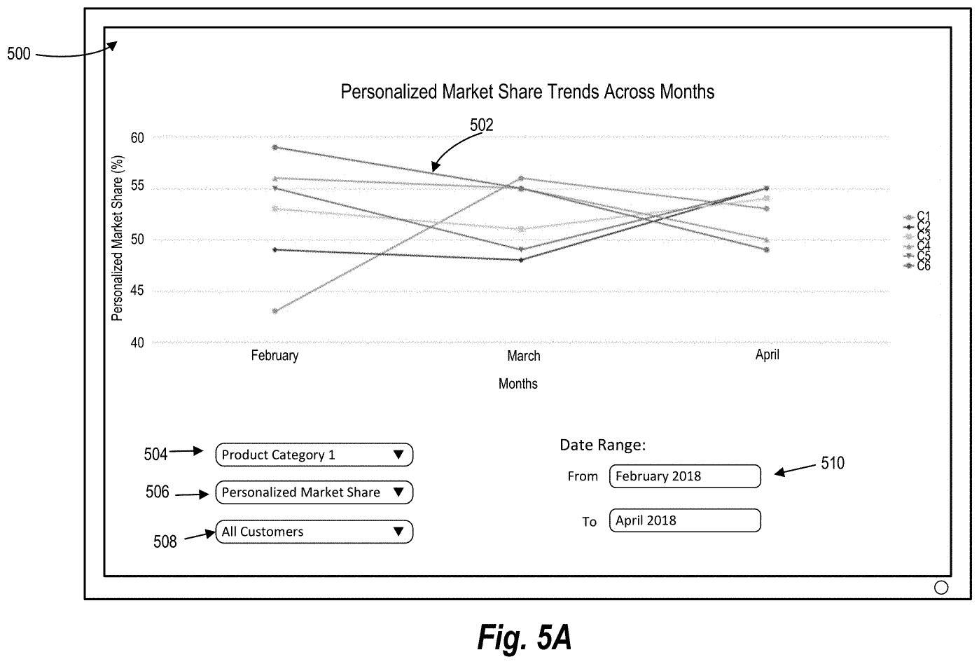

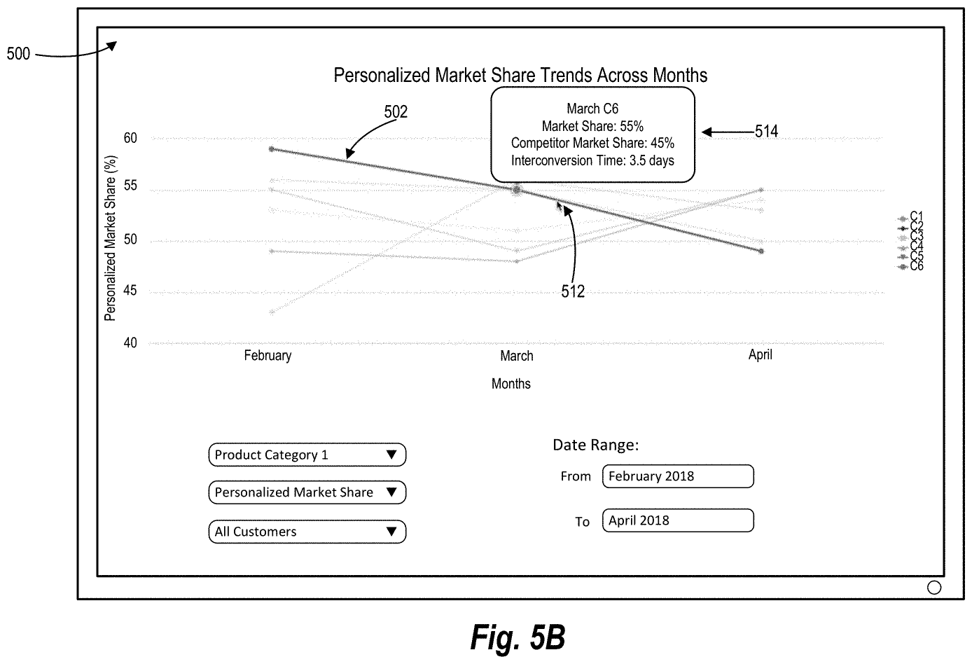

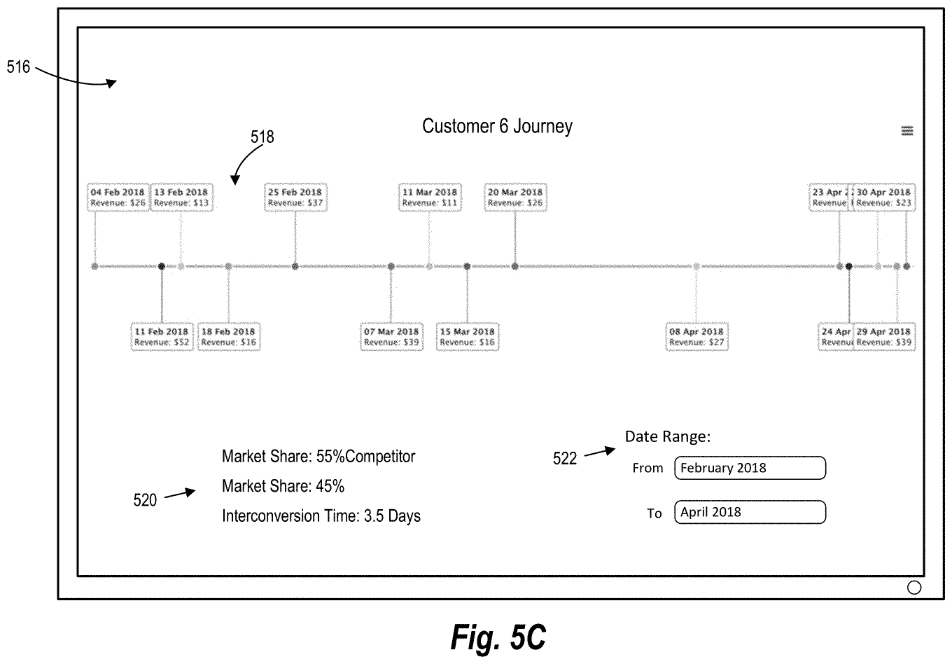

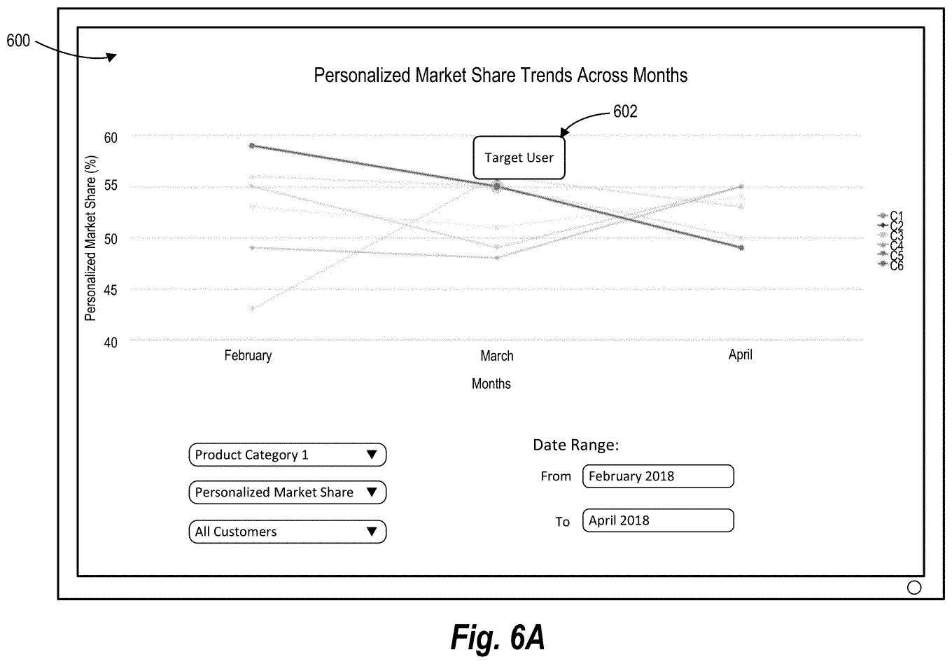

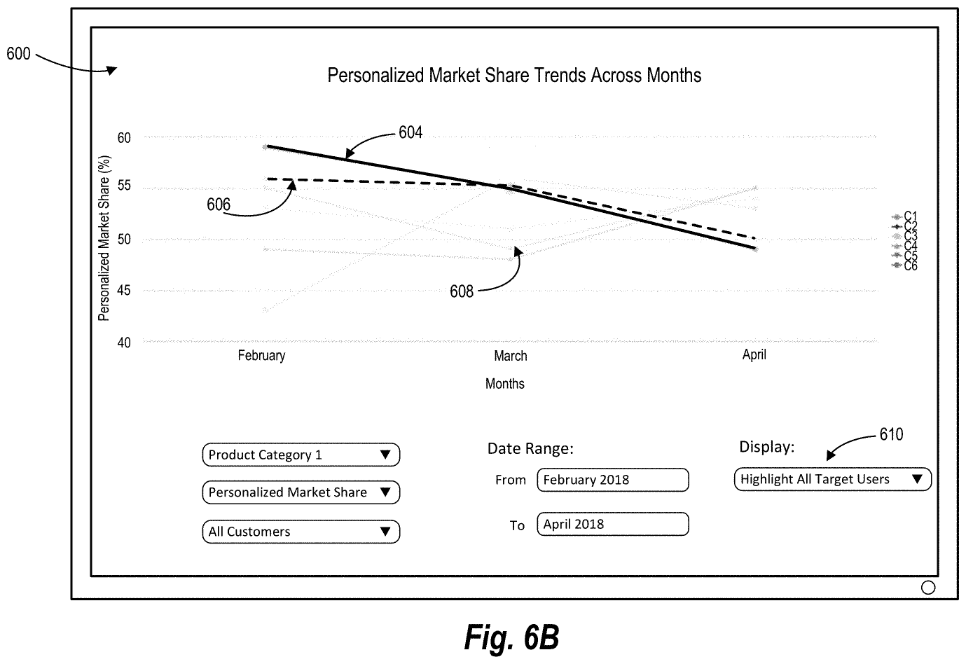

Moreover, as shown in FIG. 2, the digital personalized-market-share determination system 106 performs an act 206 of generating a graphical user interface to display personalized customer statistics based on the personalized market share. For example, the digital personalized-market-share determination system 106 can provide analytics tools with generated graphical user interfaces based on various combinations of the determined personalized market share (and/or interconversion time). For instance, as shown in FIG. 2, the digital personalized-market-share determination system 106 can generate a graphical user interface to display personalized customer statistics such as personalized market share trends of multiple individual users of a company versus competitors of the company. Additional detail regarding the digital personalized-market-share determination system 106 generating graphical user interfaces to display personalized customer statistics based on a personalized market share (and/or interconversion time) is provided below (e.g., in relation to FIGS. 5A, 5B, 5C, 6A, and 6B).

As mentioned above, the digital personalized-market-share determination system 106 can infer one or more observable conversions (in a product category) for individual users from clickstream data. For example, FIG. 3 illustrates the digital personalized-market-share determination system 106 inferring observable conversions corresponding to individual users in specific product categories from clickstream data. Indeed, as shown in FIG. 3, the digital personalized-market-share determination system 106 receives clickstream data 302 (e.g., clickstream data from user interactions of multiple users such as user IDs, device IDs, events, and timestamps for those events). Then, as shown in FIG. 3, the digital personalized-market-share determination system 106 identifies observable conversions for individual users in an act 304 (e.g., by inferring purchases and product categories for the purchases and then associating those purchases with a user). As illustrated in FIG. 3, the digital personalized-market-share determination system 106 generates datasets for observable conversions 306 for the inferred observable conversions and their product categories (e.g., a dataset which includes purchases and timestamps for each purchase in a product category).

For instance, the digital personalized-market-share determination system 106 can parse (and/or receive) clickstream data corresponding to one or more websites and/or digital applications of a company (e.g., hit-level clickstream data obtained from Adobe Analytics). In particular, the clickstream data can include user interactions (e.g., click actions) from one or more users that interact with the one or more websites and/or digital applications of the company. As an example, the clickstream data can include hit-level user interactions such as, but not limited to, navigations, payments, purchase identifiers, selections, removal of an item from a cart, server calls, submissions (e.g., as shown in FIG. 3). Moreover, in some embodiments, clickstream includes page name and/or page URL information for each specific user action event. As an example, clickstream data can include a user event and a page name and/or page URL associated with the user event (e.g., a hit-level user event of “page_nav” with a corresponding web page URL). Moreover, the clickstream data can include various types of data including data such as, but not limited to, a user identifier, a device identifier, a geographic location of the user, an IP address of a device, hit-level user event/interaction indicators, and/or timestamps.

Furthermore, in some embodiments, the clickstream data may be incomplete (e.g., the clickstream data may not contain an association with a purchase category and/or a numerical value). Indeed, clickstream data may not include a mapping (e.g., between purchases, purchase categories, and/or users). The digital personalized-market-share determination system 106 can utilize such incomplete data to infer observable conversions, product category mappings, and/or other features of user interactions.

In one or more embodiments, the digital personalized-market-share determination system 106 can infer a mapping of conversion IDs (e.g., purchase IDs indicating conversion interactions) to one or more product categories from the clickstream data based on prior hit-level interactions from the clickstream data. Then, the digital personalized-market-share determination system 106 can identify one or more conversion interactions (e.g., a conversion interaction) corresponding to a user and associate the one or more conversion interactions into different product categories by using the mapping of purchase IDs and one or more product categories. Subsequently, in some embodiments, the digital personalized-market-share determination system 106 generates a dataset of observable conversions (e.g., the conversion interactions) as a sequence with times elapsed between the observable conversions for a user with a product category.

For instance, the digital personalized-market-share determination system 106 identifies observable conversions and product purchase mappings by inferring a mapping between purchase IDs (and/or product IDs corresponding to conversion interactions) and purchase categories from clickstream data. For instance, the digital personalized-market-share determination system 106 can parse clickstream data to identify one or more conversion interactions (e.g., a hit-level data event that indicates a purchase such as a payment confirmation, a purchase ID, a checkout selection). Then, the digital personalized-market-share determination system 106 can utilize user hit-level interactions prior to the identified conversion interaction (e.g., by parsing the clickstream data) to determine a product category for the conversion interaction. In particular, the digital personalized-market-share determination system 106 can utilize the prior user hit-level interactions to determine features (e.g., time spent on various web pages, number of page views, a subsequent conversion interaction) for interactions of a user with a specific product category prior to the conversion interaction to determine that the specific product category corresponds to the conversion interaction.

For example, the digital personalized-market-share determination system 106 can utilize page names and/or page URLs associated with prior hit-level interactions to determine a product category for an identified conversion interaction in clickstream data. In particular, the digital personalized-market-share determination system 106 can determine which product category was most frequently visited by a user (e.g., based on hit-level interactions) prior to the conversion interaction in the clickstream data (e.g., based on a determined time spent on the product category and/or determined number of visits). In some embodiments, the digital personalized-market-share determination system 106 can utilize the most frequently visited product category prior to the conversion interaction as the product category mapping for the observable conversion (e.g., the conversion interaction). For instance, the digital personalized-market-share determination system 106 can determine a duration of time spent on a web page and/or number of web page visits associated with a product category based on the prior hit-level interactions from the clickstream data (e.g., using timestamps from the clickstream data).

As an example, the digital personalized-market-share determination system 106 can determine, from clickstream data, that a user interacted with a web page associated with a first product category for five minutes and interacted with a web page associated with a second product category for thirty minutes prior to a conversion interaction. Indeed, the digital personalized-market-share determination system 106 can determine that the user interacted with the second product category for a greater amount of time in comparison to the first category and, therefore, likely made a conversion interaction that corresponds to the second category. Then, the digital personalized-market-share determination system 106 can map the conversion interaction (e.g., using a purchase ID, confirmation ID, or other indicator of the conversion interaction from hit-level data) to the second product category.

In some embodiments, the digital personalized-market-share determination system 106 utilizes a sequence of events identified from clickstream data to map a conversion interaction (e.g., using a product ID) to a product category. For example, the digital personalized-market-share determination system 106 can determine a sequence of events from the clickstream data indicating that a user navigated to a web page associated with a first product category, then navigated to a web page associated with a second product category, and then navigated to a checkout web page. Subsequently, the digital personalized-market-share determination system 106 can determine that the user purchased a product corresponding to the second product category based on the above sequence of events and map the conversion interaction to the second product category. Indeed, the digital personalized-market-share determination system 106 can utilize various sequences of events identified from clickstream data prior to a conversion interaction to map a conversion interaction to a product category.

Moreover, as mentioned above, the digital personalized-market-share determination system 106 can identify one or more conversion interactions corresponding to a user and associate the one or more conversion interactions into different product categories. In particular, the digital personalized-market-share determination system 106 can utilize a mapping between purchase IDs and one or more product categories to associate the one or more conversion interactions to product categories. For instance, the digital personalized-market-share determination system 106 can identify clickstream data that corresponds with a user and then identify a conversion interaction within the clickstream data. Subsequently, the digital personalized-market-share determination system 106 can utilize information associated with an identified conversion interaction (e.g., a purchase ID) to determine a product category for the conversion interaction of the user.

Additionally, the digital personalized-market-share determination system 106 can utilize a threshold duration of time to determine a proximity between hit-level interactions and a conversion interaction. For instance, the digital personalized-market-share determination system 106 can determine that prior hit-level interactions are associated with a conversion interaction when the prior hit-level interactions occur within a threshold duration of time from the conversion interaction (e.g., within fifteen minutes of the conversion interaction). Then, the digital personalized-market-share determination system 106 can utilize product categories associated with the prior hit-level interactions that occur within the threshold duration of time to determine a mapping for the conversion interaction. Indeed, the digital personalized-market-share determination system 106 can receive configurations for the threshold duration of time by an administrator using analytics tools corresponding to the digital personalized-market-share determination system 106.

Furthermore, the digital personalized-market-share determination system 106 can also determine multiple purchase categories for a conversion interaction when the conversion interaction includes multiple purchases (or products). In particular, the digital personalized-market-share determination system 106 can utilize prior hit-level interaction data to determine more than one product category association for a conversion interaction upon determining that the conversion interaction includes multiple products. For example, the digital personalized-market-share determination system 106 can determine that a conversion interaction within clickstream data indicates three product purchases. Subsequently, the digital personalized-market-share determination system 106 can utilize prior hit-level interaction data to identify multiple pages visited that correspond to three different product categories within a threshold duration of time to the conversion interaction (as described above). Then, the digital personalized-market-share determination system 106 can map the conversion interaction to the three different product categories based on such prior hit-level interaction data.

In some embodiments, the digital personalized-market-share determination system 106 can determine a series of conversion interactions (e.g., a hit-level journey) within a product category by using the mappings between purchase IDs and product categories. Moreover, the digital personalized-market-share determination system 106 can utilize the series of conversion interactions (e.g., the hit-level journey) for model estimations (as described below) if the series of conversion interactions meets a threshold number of purchases. In particular, the digital personalized-market-share determination system 106 can determine a threshold number of purchases (e.g., by configuration from an administrator of the digital personalized-market-share determination system 106) and determine if the series of conversion interactions meets the threshold number of purchases prior to using the series of conversion interactions in a dataset for determining a personalized market share and/or interconversion time. For example, in some embodiments, the digital personalized-market-share determination system 106 utilizes the series of conversion interactions when there are three or more conversion interactions available for a user from the clickstream data.

Additionally, the digital personalized-market-share determination system 106 can identify and associate one or more conversion interactions into one or more product categories from clickstream data that are confined to a time frame (or duration). In particular, the digital personalized-market-share determination system 106 can receive a duration over which conversion interactions should be identified in clickstream data. Indeed, the digital personalized-market-share determination system 106 can identify conversion interactions (or a series of conversion interactions) for a user from clickstream data that is within the received duration (e.g., based on timestamps). Furthermore, the digital personalized-market-share determination system 106 can associate such identified conversion interactions (or a series of conversion interactions) to one or more product categories. In one or more embodiments, the digital personalized-market-share determination system 106 can determine a duration over which conversion interactions should be identified in clickstream data based on configurations provided by an administrator (e.g., an administrator using an application corresponding to the digital personalized-market-share determination system 106).

In some embodiments, the digital personalized-market-share determination system 106 can also determine user features (or attributes) from the clickstream data. For instance, the digital personalized-market-share determination system 106 can determine a duration of time that a user spends within a URL page that corresponds to a specific category and/or number of visits to the URL page. Additionally, when available in the clickstream data, the digital personalized-market-share determination system 106 can also determine an amount of money spent during a conversion interaction for a user. Indeed, the digital personalized-market-share determination system 106 can determine a variety of features (or attributes) associated with a user from clickstream data including, but not limited to, monetary values spent on a conversion interaction, monetary values spent within a product category, frequency of visits to one or more websites corresponding to the company, and/or payment type used. Moreover, the digital personalized-market-share determination system 106 can associate such features with conversion interactions identified from clickstream data.

Moreover, the digital personalized-market-share determination system 106 can generate a dataset of observable conversions for specific product categories and/or users. For instance, the digital personalized-market-share determination system 106 can generate a dataset of observable conversions using identified conversion interactions (and product category mappings) for one or more users. In particular, the digital personalized-market-share determination system 106 can generate a dataset, for a category, having a row with user specific conversion interactions as a sequence with a time elapsed (e.g., using timestamps) between the conversion interactions and/or other user features. In some embodiments, the digital personalized-market-share determination system 106 includes an interconversion time between the observable conversions within the dataset of observable conversions.

Indeed, the digital personalized-market-share determination system 106 can generate the dataset to have such a row for each user that includes conversion interactions for the product category from the clickstream data. In one or more embodiments, the digital personalized-market-share determination system 106 generates, for each product category, a dataset with as many rows as users and where the number of columns is the maximum number of conversion interactions and/or user features available across the users (e.g., to each user) from the clickstream data (for the specific product category). Accordingly, the digital personalized-market-share determination system 106 can generate a dataset of observable conversions for one or more product categories from identified conversion interactions and their corresponding product categories for each user from the clickstream data (e.g., the datasets of observable conversions 306). In some embodiments, the digital personalized-market-share determination system 106 utilizes the dataset of observable conversions corresponding to a product category to determine personalized market shares and interconversion times within the product category.

Furthermore, the digital personalized-market-share determination system 106 can also include additional user information within a dataset of observable conversions. For instance, the digital personalized-market-share determination system 106 can include user information such as known spend per conversion interaction, demographic information, contact information, membership and/or loyalty information, and/or product ownership information (e.g., known products that are owned by the user). Indeed, in some embodiments, such information may not be readily available from clickstream data and the digital personalized-market-share determination system 106 can fetch such information (e.g., from a database and/or third party) for a user using an identified user ID of the user from the clickstream data. In particular, the digital personalized-market-share determination system 106 can record prior hit-level user interactions (e.g., such as conversion interactions) and/or other user information provided by the user (e.g., times between purchases and/or value of purchases) within a database (e.g., a database belonging to the server device(s) 102, the client device 114, and/or a third party).

Additionally, the digital personalized-market-share determination system 106 can infer an observable conversion (e.g., conversion interaction) for a user, map the observable conversion to a product category, and include the conversion interaction within a dataset of observable conversions in a specific product category for a user while parsing clickstream data. In particular, the digital personalized-market-share determination system 106 can determine mappings between a conversion interaction and a product category based on prior hit-level interactions. Additionally, the digital personalized-market-share determination system 106 can include the conversion interaction within an observable conversion dataset corresponding to the product category when the conversion interaction clickstream data is received. For instance, in one or more embodiments, the digital personalized-market-share determination system 106 can actively monitor clickstream data to continuously infer mappings between conversion interactions and product categories to include the conversion interaction within a dataset of observable conversions that corresponds to the mapped product category.

Furthermore, in some embodiments, the digital personalized-market-share determination system 106 can utilize a grouping of multiple product categories as an overarching product category. For instance, the digital personalized-market-share determination system 106 can group multiple product categories together and generate a dataset of observable conversions for the overarching product category. In particular, the digital personalized-market-share determination system 106 can include conversion interactions (and/or other user features) from each of the product categories that form the overarching product category in a dataset of observable conversions corresponding to the overarching product category. Indeed, the digital personalized-market-share determination system 106 can utilize the dataset of observable conversions corresponding to the overarching product category to determine personalized market shares and interconversion times within the overarching product category. In some embodiments, the digital personalized-market-share determination system 106 utilizes an overarching product category when individual product categories include large durations of time between purchases (e.g., a low frequency of purchases in product categories associated with larger and/or expensive products).

Moreover, although the digital personalized-market-share determination system 106 utilizes different datasets of observable conversions for different product categories in one or more embodiments herein, the digital personalized-market-share determination system 106 can utilize a single dataset of observable conversions that includes user data, conversion interactions of those users, and an association to a product category for the conversion interactions. Indeed, the digital personalized-market-share determination system 106 can reference the single database of observable conversions to retrieve conversion interactions (and/or other user features) of a specific user and/or for a specific product category with time information (e.g., an elapsed time between the conversion interactions). In addition, the digital personalized-market-share determination system 106 can infer product ID (or conversion interaction) mappings to product categories and generate a dataset of observable conversions (as described above) for any number of users, purchases, and/or product categories.

As mentioned above, the digital personalized-market-share determination system 106 can determine personalized market shares (and/or interconversion times) for individual users between a company and competitors of the company using the clickstream data. For instance, the digital personalized-market-share determination system 106 can utilize a dataset of observable conversions that is generated from clickstream data to determine personalized market shares (and/or interconversion times) for individual users. Moreover, as previously mentioned, the digital personalized-market-share determination system 106 can estimate one or more conversion probability parameters and other parameters (e.g., a scale parameter) for individual users to determine a personalized market share and/or interconversion time for the individual user without relying on data that is inaccessible to the company (e.g., a competitor's user interaction data).

For example, FIG. 4 illustrates the digital personalized-market-share determination system 106 determining a personalized market share and interconversion time for an individual user. In particular, as shown in FIG. 4, the digital personalized-market-share determination system 106 utilizes observable conversions (and interconversion times between the observable conversions) within a first product category 402 (e.g., purchases corresponding to an individual user) and user data 404 (e.g., user data corresponding to the individual user) to determine a personalized market share in an act 406 and determine an interconversion time in an act 408. Indeed, the digital personalized-market-share determination system 106 can determine the personalized market share in the act 406 and determine the interconversion time the act 408 across the company and competitors of the company (e.g., using an interconversion time distribution model and a two state conversion probability model as described below). As shown in FIG. 4, the digital personalized-market-share determination system 106 determines a personalized market share 410 (e.g., 35%) and an interconversion time 412 (e.g., 2.3 days) for a first user in the first product category.

In one or more embodiments, the digital personalized-market-share determination system 106 utilizes a dataset of observable conversions (e.g., conversion interactions determined from clickstream data) within a product category to determine personalized market shares and/or interconversion times for individual users within the product category. For instance, the digital personalized-market-share determination system 106 can utilize observable conversions within a product category of each user to determine a personalized market share and/or interconversion time for an individual user within the product category. In some embodiments, the digital personalized-market-share determination system 106 utilizes observable conversions within a product category that correspond to an individual user to determine a personalized market share and/or an interconversion time for the individual user within the product category.

Additionally, in some embodiments, the digital personalized-market-share determination system 106 can also utilize user data corresponding to one or more users associated with a dataset of observable conversions within a product category to determine personalized market shares and/or interconversion times for individual users within the product category. For instance, the digital personalized-market-share determination system 106 can utilize user data such as, but not limited to, spend per conversion interaction, demographic information, contact information, membership and/or loyalty information, and/or product ownership information (e.g., known products that are owned by the user) associated with the one or more users. Moreover, in some embodiments, the digital personalized-market-share determination system 106 can determine a personalized market share and/or interconversion time (in accordance with one or more embodiments herein) without utilizing such user data. In particular, the digital personalized-market-share determination system 106 can determine a personalized market share and/or interconversion time for an individual user within a product category using observable conversions within the product category.

Moreover, in one or more embodiments, the digital personalized-market-share determination system 106 can utilize one or more specific types of user data. For instance, the digital personalized-market-share determination system 106 can receive a selection of one or more specific types of user data to utilize (e.g., from an administrator). Subsequently, the digital personalized-market-share determination system 106 can determine personalized market shares and/or interconversion times for individual users based on user data corresponding to the selected specific types of user data (in addition to the observable conversions). For example, the digital personalized-market-share determination system 106 can receive a selection to include spend per conversion interaction and product ownership information as a specific type of user data to utilize. Then, as an example, the digital personalized-market-share determination system 106 can determine personalized market shares and/or interconversion times for individual users based on spend per conversion interaction and product ownership information in addition to the known observable conversions.

As previously mentioned, in some embodiments, the digital personalized-market-share determination system 106 models user purchase transition probabilities between companies and interconversion time distributions to determine personalized market shares and/or interconversion times for individual users (e.g., with a goal of minimizing a negative log likelihood). In particular, the digital personalized-market-share determination system 106 can utilize a dataset of observable conversion interactions within a product category (e.g., identified from clickstream data) to estimate one or more conversion probability parameters and/or scale parameters for individual users (as described below). Then, in one or more embodiments, the digital personalized-market-share determination system 106 determines a personalized market share for an individual user within the product category using the one or more conversion probability parameters. Moreover, in some embodiments, the digital personalized-market-share determination system 106 also determines an interconversion time for the individual user across the company and the competitors of the company using the interconversion time distribution model, the scale parameter, and the estimate one or more conversion probability parameters.

For instance, the digital personalized-market-share determination system 106 can model a category-level interconversion time for each user (e.g., using a probability distribution). Moreover, the digital personalized-market-share determination system 106 can create a two-state first-order Markov Chain where the two states correspond to (i) a user purchasing from a company and (ii) a user purchasing from all other competitors the product category. Additionally, the digital personalized-market-share determination system 106 can generate a transition probability matrix that represents the probabilities of a user staying with the company versus going to a competitor for a subsequent purchase. Then, the digital personalized-market-share determination system 106 can estimate the parameters of these models to determine a personalized market share and interconversion time for the user. Indeed, the digital personalized-market-share determination system 106 can estimate the parameters of an interconversion time distribution and the purchase transition probabilities from a Hierarchical Bayes estimation that uses a Markov Chain Monte Carlo approach. For example, the digital personalized-market-share determination system 106 determining a personalized market share and/or an interconversion time using the above mentioned approaches is described in greater detail below.

In particular, the digital personalized-market-share determination system 106 can model category-level interconversion times for each individual user (e.g., for i users) using a probability distribution (e.g., a Gamma distribution). For instance, in some embodiments, the digital personalized-market-share determination system 106 can utilize an Erlang-2 distribution (e.g., a Gamma distribution with a shape parameter of 2) having a scale parameter βᵢ corresponding to an i^{th} user. In some embodiments, the digital personalized-market-share determination system 106 utilizes a property of an Erlang-2 distribution where the sum of k independent Erlang-2 random variables with the same scale parameter is also an Erlang random variable with shape 2k and the same scale parameter. Indeed, the digital personalized-market-share determination system 106 can model category-level interconversion times for individual users (e.g., for an observed purchase at time t) using the following function:

$$Erlang ( t ; s , {β}_{i} ) = \frac{{β}_{i}^{s} {t}^{s - 1} {e}^{- {β}_{i} t}}{( s - 1 ) !} where s = 2 for Erlang \text{-} 2.$$

Moreover, the digital personalized-market-share determination system 106 can model user transition probabilities between companies to determine personalized market shares for individual users. For instance, in one or more embodiments, the digital personalized-market-share determination system 106 can model the probabilities (e.g., transition probabilities) of a user (e.g., a customer) performs a conversion from a company platform (e.g., the observed conversions) or from a platform corresponding to a competitor of the company (e.g., an unobserved conversion) on each conversion interaction (or purchase occasion) for a product category. Indeed, the digital personalized-market-share determination system 106 can utilize a Markov Chain to model the transition probabilities of users.

In particular, the digital personalized-market-share determination system 106 can represent the probability (i.e., transition probability) that the i^{th} user that purchases from a company (e.g., the focal company) returns to the company for the next purchase as Oi. Moreover, the digital personalized-market-share determination system 106 can represent the probability (i.e., transition probability) that the i^{th} user that purchases from a competitor of the company comes to the company for the next purchase as λᵢ. Indeed, the digital personalized-market-share determination system 106 can utilize a Markov Chain Transition Diagram for a customer i as shown in FIG. 4B (e.g., where 1−ϕᵢ represents a probability that a user i that purchases from the company will go to a competitor for the next purchase and where 1−λᵢ represents a probability that a user i that purchases from a competitor will also make a subsequent purchase with the competitor). Furthermore, the digital personalized-market-share determination system 106 can generate a purchase transition probability matrix for the Markov Chain (as illustrated in FIG. 4B) for a customer i. In some embodiments, the digital personalized-market-share determination system 106 utilizes the following transition probability matrix:

$$[ \begin{matrix}{φ}_{i} & 1 - {φ}_{i} \\ {λ}_{i} & 1 - {λ}_{i}\end{matrix} ] .$$

Moreover, the digital personalized-market-share determination system 106 can utilize the Markov Chain for a customer i to determine a personalized market share for the user. More specifically, in some embodiments, the digital personalized-market-share determination system 106 can utilize a steady state probability of the customer i staying with a company (e.g., a transition probability matrix) to determine a personalized market share (e.g., represented as SOWᵢ). For example, the digital personalized-market-share determination system 106 can determine a personalized market share for an individual user within a product category using the following functions:

$${SOW}_{i} \cdot {φ}_{i} + ( 1 - s o {w}_{i} ) \cdot {λ}_{i} = {SOW}_{i} , \\ {SOW}_{i} = \frac{{λ}_{i}}{1 + {λ}_{i} - {φ}_{i}} .$$

Additionally, the digital personalized-market-share determination system 106 can utilize an interconversion time distribution model and one or more transition probabilities to determine an interconversion time for an individual user within a product category. For instance, the digital personalized-market-share determination system 106 can determine a probability for a number of unobserved purchases (e.g., purchases corresponding to competitors of a focal company) occurring between two observed purchases. In particular, the digital personalized-market-share determination system 106 can determine the probability that there are k unobserved purchases between two observed purchases using the following function:

$${Q}_{i} ( k , {φ}_{i} , {λ}_{i} ) = \{ \begin{matrix}{φ}_{i} & k = 0 \\ ( 1 - {φ}_{i} ) {( 1 - {λ}_{i} )}^{k - 1} {λ}_{i} & k > 0\end{matrix} .$$

Then, the digital personalized-market-share determination system 106 can determine a focal company-level interconversion time distribution. In particular, in one or more embodiments, the digital personalized-market-share determination system 106 can utilize the k unobserved purchases (corresponding to competitors) between two observed purchases (corresponding to the focal company) for a user i to determine the interconversion time between the two observed purchases. For instance, the digital personalized-market-share determination system 106 can determine the interconversion time between the two observed purchases for a user i by utilizing the sum of k+1 random variables with the interconversion time distribution model (e.g., the Erlang-2 distribution) with a scale parameter βᵢ. Indeed, the digital personalized-market-share determination system 106 can obtain the Erlang-2 distribution with a shape parameter 2(k+1) (e.g., the sum of random unobservable conversions) and scale parameter βᵢ. In particular, the digital personalized-market-share determination system 106 can obtain the Erlang-2 distribution with a shape parameter 2(k+1) using the following function:

$$E r l ang \text{-} 2 ( t ; s , {β}_{i} ) = \frac{{β}_{i}^{S} {t}^{s - 1} {e}^{- {β}_{i} t}}{( s - 1 ) !} where s = 2 ( k + 1 ) .$$

Moreover, the digital personalized-market-share determination system 106 can determine an interconversion time between two observed purchases for an individual user i based on the probability that there are k unobserved purchases between two observed purchases and the interconversion time distribution model with a shape parameter of 2(k+1). Indeed, the digital personalized-market-share determination system 106 can determine the interconversion time between the two observed purchases as an interconversion time for an individual user across the focal company and competitors of the company (e.g., unobserved purchases). For instance, the digital personalized-market-share determination system 106 can determine the interconversion time for the user i by determining the product of the probability that there are k unobserved purchases between two observed purchases and the interconversion time distribution model with a shape parameter of 2(k+1) (e.g., applying rules of conditional probability given that there are k unobserved purchases between the observed purchases). For example, the digital personalized-market-share determination system 106 can determine the interconversion time for the user i (within a product category) for an unknown k number of unobserved purchases by using the following function:

gᵢ(t;βᵢ,ϕᵢ,λᵢ)=Σₖ₌₀^{∞}Erlang−2(t;2(k+1),βᵢ)·Qᵢ(k,ϕᵢ,λᵢ).

In some embodiments, the digital personalized-market-share determination system 106 utilizes properties of an interconversion time distribution model and personalized market share (e.g., determined using a steady state probability as described above) to determine an interconversion time between two observed purchases for a user (e.g., an estimated time between observed purchases). More specifically, the digital personalized-market-share determination system 106 can determine an interconversion time for a user by dividing the interconversion time distribution (e.g., the Erlang-2 distribution model) by a personalized market share (e.g., SOWᵢ). For instance, the digital personalized-market-share determination system 106 can determine the interconversion time for a user i (within a product category) based on a scaling parameter (βᵢ) corresponding to an interconversion distribution model and conversion probabilities (λᵢ and ϕᵢ) by using the following function:

$$( \frac{2}{{β}_{i}} ) ( \frac{{λ}_{i} + ( 1 - {φ}_{i} )}{{λ}_{i}} ) .$$

Furthermore, the digital personalized-market-share determination system 106 can estimate the scaling parameter (βᵢ) and conversion or conversion probabilities (λᵢ and ϕᵢ). In particular, the digital personalized-market-share determination system 106 can estimate the scaling parameter (βᵢ) and conversion probabilities (λᵢ and ϕᵢ) for a user i based on a dataset of observable conversions. In some embodiments, the digital personalized-market-share determination system 106 utilizes a Bayesian method (e.g., a Hierarchical Bayes approach) to estimate the scaling parameter (βᵢ) and conversion probabilities (λᵢ and ϕᵢ) for a user i. By utilizing a Bayesian method to estimate the scaling parameter (βᵢ) and conversion probabilities (λᵢ and ϕᵢ), the digital personalized-market-share determination system 106 can determine an accurate scaling parameter (βᵢ) and conversion probabilities (λᵢ and ϕᵢ) regardless of the availability of data points for individual users. For instance, a Bayesian method allows for an accurate estimation of individual level parameters when very few data points exist per individual.

Indeed, a digital personalized-market-share determination system 106 can estimate the scaling parameter (βᵢ) and conversion probabilities (λᵢ and ϕᵢ) for a user i using a Hierarchical Bayes approach with the reparametrized. In particular, the digital personalized-market-share determination system 106 can reparametrize βᵢ to be a positive quantity. Moreover, the digital personalized-market-share determination system 106 can reparametrize the conversion probabilities (λᵢ and ϕᵢ) to be between 0 and 1. For instance, the digital personalized-market-share determination system 106 can reparametrize the scaling parameter (βᵢ) and conversion probabilities (λᵢ and ϕᵢ) according to the following:

$${θ}_{{β}_{t}} = exp ( {β}_{i} ) , {θ}_{{φ}_{i}} = \frac{exp ( {φ}_{i} )}{1 + exp ( {φ}_{i} )} , and {θ}_{{λ}_{i}} = \frac{exp ( {λ}_{i} )}{1 + exp ( {λ}_{i} )} .$$

Additionally, in one or more embodiments, the digital personalized-market-share determination system 106 utilizes a Markov Chain Monte Carlo (“MCMC”) method to generate samples from a conditional posterior distribution (e.g., to estimate the scaling parameter (βᵢ) and conversion probabilities (λᵢ and ϕᵢ) using the Hierarchical Bayes approach). For instance, the digital personalized-market-share determination system 106 can utilize a Metropolis Hastings algorithm along with Gibbs sampling. As an illustration, the digital personalized-market-share determination system 106 can account for all i users (e.g., customers) in each iteration of the Metropolis Hastings algorithm. In one or more embodiments, the digital personalized-market-share determination system 106 defines θᵢ (e.g., samples from a conditional posterior distribution) according to the following

$${θ}_{i} = ( \begin{matrix}{θ}_{{β}_{i}} \\ {θ}_{{φ}_{i}} \\ {θ}_{{λ}_{i}}\end{matrix} ) = ( \begin{matrix}{X}_{{β}_{i}} η \\ {X}_{{φ}_{i}} γ \\ {X}_{{λ}_{i}} δ\end{matrix} ) + ( \begin{matrix}{ϵ}_{{β}_{i}} \\ {ϵ}_{{φ}_{i}} \\ {ϵ}_{{λ}_{i}}\end{matrix} ) = \overline{{Θ}_{ι}} + {ϵ}_{i} .$$

Although one or more embodiments above describe the digital personalized-market-share determination system 106 utilizing an MCMC method with a Metropolis Hastings algorithm, the digital personalized-market-share determination system 106 can utilize various approaches to estimate one or more parameters for users.

Moreover, in some embodiments, the digital personalized-market-share determination system 106 defines the mean Θ̅ₗ as a product of the covariates X_{ϕ}_{ᵢ}, X_{λ}_{ᵢ}, and X_{β}_{ᵢ} with the corresponding coefficients (γ, δ, and η). For instance, the digital personalized-market-share determination system 106 can model the values of θ_{β}_{ᵢ}, θ_{ϕ}_{ᵢ}, and θ_{β}_{ᵢ} through a regression model (e.g., a linear regression model). Indeed, the digital personalized-market-share determination system 106 can utilize a product of two matrices to represent Θ̅ₗ. For example, in one or more embodiments, the digital personalized-market-share determination system 106 defines Θ̅ₗ using matrices by using the following function:

$$\begin{matrix}{A}_{i} = [ \begin{matrix}{X}_{{β}_{{i}_{1}}} & {X}_{{β}_{{i}_{1}}} & … & {X}_{{β}_{{i}_{{β}_{len}}}} & 0 & 0 & … & 0 & 0 & 0 & … & 0 \\ 0 & 0 & … & 0 & {X}_{{φ}_{{i}_{1}}} & {X}_{{φ}_{{i}_{2}}} & … & {X}_{{φ}_{{i}_{{φ}_{len}}}} & 0 & 0 & … & 0 \\ 0 & 0 & … & 0 & 0 & 0 & … & 0 & {X}_{{λ}_{{i}_{1}}} & {X}_{{λ}_{{i}_{2}}} & … & {X}_{{λ}_{{i}_{{λ}_{len}}}}\end{matrix} ] , & \\ B = [ \begin{matrix}{η}_{1} \\ {η}_{2} \\ … \\ {γ}_{1} \\ {γ}_{2} \\ … \\ {γ}_{{γ}_{len}} \\ {δ}_{1} \\ {δ}_{2} \\ … \\ {δ}_{{δ}_{len}}\end{matrix} ] , and \\ \overline{{Θ}_{ι}} = {A}_{i} B . & \end{matrix}$$

In one or more embodiments, the digital personalized-market-share determination system 106 can utilize a dataset of observable conversions (determined in accordance with one or more embodiments herein) for the covariates (X_{ϕ}_{ᵢ}, X_{λ}_{ᵢ}, and X_{β}_{ᵢ}). For example, the digital personalized-market-share determination system 106 can represent a dataset of observable conversions within a product category for an individual user i as the covariates (X_{ϕ}_{ᵢ}, X_{λ}_{ᵢ}, and X_{β}_{ᵢ}). Moreover, in some embodiments, the digital personalized-market-share determination system 106 can include user data (as described above) for an individual user i in the covariates (X_{ϕ}_{ᵢ}, X_{λ}_{ᵢ}, and X_{β}_{ᵢ}). Indeed, in some embodiments, the digital personalized-market-share determination system 106 utilizes user data and/or observable conversion data that may affect a time between purchases to define covariates that define the scaling parameter βᵢ. Furthermore, the digital personalized-market-share determination system 106 can include user data and/or observable conversion data that may affect (or are positively related to) a user's decision to where to purchase a product (e.g., between the company and competitors) to define covariates that define the conversion probabilities λᵢ and ϕᵢ.

Moreover, the digital personalized-market-share determination system 106 can utilize an error term ∈ᵢ that is drawn from a normal distribution. For example, the digital personalized-market-share determination system 106 can utilize an error term ∈ᵢ that is drawn from a normal distribution with a mean of 0 and a covariance Ω. Indeed, the digital personalized-market-share determination system 106 can obtain an error term ∈ᵢ and represent Θᵢ (e.g., samples from a conditional posterior distribution) in terms of matrices (as described above) according to the following:

$${ϵ}_{i} = ( \begin{matrix}{ϵ}_{{φ}_{i}} \\ {ϵ}_{{λ}_{i}} \\ {ϵ}_{{β}_{i}}\end{matrix} ) ∼ Normal ( 0 , Ω ) and {Θ}_{i} = {A}_{i} B + {ϵ}_{i} .$$

Additionally, in a first step of a Metropolis Hastings algorithm, the digital personalized-market-share determination system 106 can randomly sample Θᵢ. For instance, the digital personalized-market-share determination system 106 can randomly sample Θᵢ using a conditional posterior distribution function (e.g., represented as f below). In some embodiments, the digital personalized-market-share determination system 106 randomly samples Θᵢ using a conditional posterior distribution function that is a multivariate normal distribution with mean Θ̅₁ and a covariance Ω multiplied by the likelihood per user (e.g., a likelihood of various interconversion times per user). For instance, the digital personalized-market-share determination system 106 can randomly sample Θᵢ using a conditional posterior distribution function that is a multivariate normal distribution with mean Θ̅ₗ and a covariance Ω multiplied by the likelihood per user (where i represents the i^{th} user and j represents the j^{th} observed interconversion time) by using the function:

$$f ( {θ}_{i} ) ∝ {\vert Ω \vert}^{- 1 / 2} exp [ - 1 / 2 {( {Θ}_{i} - \overline{{Θ}_{ι}} )}^{T} {Ω}^{- 1} ( {Θ}_{i} - \overline{{Θ}_{ι}} ) ] {\prod }_{j = 1}^{m} {g}_{i} ( {t}_{ij} \vert {Θ}_{i} )$$

In addition, the digital personalized-market-share determination system 106 can update the generated sample (e.g., Θᵢ) using random noise. In particular, the digital personalized-market-share determination system 106 can utilize a random noise (e.g., represented as Δ) that is drawn from a normal distribution with mean 0 and a variance with a value (scale) that is defined via settings and/or configurations (e.g., by an administrator). For example, in some embodiments, the digital personalized-market-share determination system 106 can utilize a variance with a value (scale) of 0.01 and/or 0.3. For example, the digital personalized-market-share determination system 106 can utilize a random noise (Δ) drawn from a normal distribution to update the generated sample (Θᵢ) by using the functions:

Δ˜Normal(0,scale) and Θᵢ⁽ⁿ⁾=Θᵢ^{(p)}+Δ.

Moreover, the digital personalized-market-share determination system 106 accepts or rejects the updated sample (Θᵢ⁽ⁿ⁾) by utilizing an acceptance condition (e.g., as part of the Metropolis Hastings algorithm). In particular, the digital personalized-market-share determination system 106 accepts the updated sample (Θᵢ⁽ⁿ⁾) if a randomly chosen number between 0 and 1 is less than a value based on the updated sample (Θᵢ⁽ⁿ⁾) and the previous sample (Θᵢ^{(p)}) and utilizes the accepted sample (Θᵢ⁽ⁿ⁾) in a list of generated samples (e.g., for each user i). Otherwise, the digital personalized-market-share determination system 106 rejects the updated sample (Θᵢ⁽ⁿ⁾) and utilizes the previous sample (Θᵢ^{(p)}) in a list of generated samples. For example, the digital personalized-market-share determination system 106 can accept the updated sample (Θᵢ⁽ⁿ⁾) if a randomly chosen number between 0 and 1 is less than the value:

$$min [ \frac{f ( {Θ}_{i}^{( n )} )}{f ( ( {Θ}_{i}^{( p )} )} , 1 ] .$$

Furthermore, the digital personalized-market-share determination system 106 can store the generated sample (e.g., the updated sample (Θᵢ⁽ⁿ⁾), if accepted, or the previous sample (Θᵢ^{(p)}) in a list of updated generated samples (Θᵢ). Indeed, the digital personalized-market-share determination system 106 utilizes the MCMC method to draw parameters and define the conditional posterior distribution such that a log likelihood converges to a stable value. In particular, the digital personalized-market-share determination system 106 can utilize the MCMC method to update drawn parameters and values for the conditional posterior distribution to update a log likelihood for each user. Then, the digital personalized-market-share determination system 106 can utilize the log likelihoods for each user over the MCMC updates (e.g., a summation of the log likelihoods across all users) to reduce the log likelihood and stabilize parameter estimations (e.g., prior to drawing final parameters and values) for users).

Subsequently, the digital personalized-market-share determination system 106 can generate values for the coefficients (γ, δ, and η) using the updated samples (Θᵢ). For example, digital personalized-market-share determination system 106 can represent the matrix (as described above) of the coefficients (γ, δ, η) and by using the function:

B=C(Θᵢ−∈₁) where C=(A^{T}A)⁻¹A^{T}.

In addition, the digital personalized-market-share determination system 106 can then represent the conditional distribution of matrix B (i.e., coefficients γ, δ, and η) using multivariate normal distributions. For instance, in some embodiments, the digital personalized-market-share determination system 106 represents the conditional distribution of matrix B (i.e., coefficients γ, δ, and η) as a product of n multivariate normal distributions with mean CᵢΘᵢ and a covariance CᵢΩCᵢ^{T}. In some embodiments, the digital personalized-market-share determination system 106 can utilize the product of two multivariate normal distributions MVN(μ₁, Σ₁) and MVN(μ₂, Σ₂) represented as a multivariate normal distribution with mean μ₃ and covariance Σ₃ according to the following:

μ₃=Σ₂(Σ₁+Σ₂)⁻¹μ₁+Σ₁(Σ₁+Σ₂)⁻μ₂ and Σ₃=Σ₁(Σ₁+Σ₂)⁻¹Σ₂.

Moreover, by repeatedly applying the above function for the multivariate normal distribution with mean μ₃ and covariance Σ₃, the digital personalized-market-share determination system 106 can obtain an effective mean and covariance for the product of n such multivariate normal distributions. Then, the digital personalized-market-share determination system 106 can obtain a sample of coefficients γ, δ, and η based on the product of the above multivariate normal distribution. In particular, the digital personalized-market-share determination system 106 determines the product of the above multivariate normal distribution with a prior of the coefficients γ, δ, and η. Indeed, the digital personalized-market-share determination system 106 can represent the prior of the coefficients γ, δ, and η as a multivariate normal distribution with a mean 0 and a covariance 100I according to the following: P(η, γ, δ)˜Normal (0, 100I). Subsequently, the digital personalized-market-share determination system 106 once again can apply the multivariate normal distribution with mean μ₃ and covariance Σ₃ to obtain the final distribution from which coefficients γ, δ, and η are drawn.

In some embodiments, by utilizing a multivariate normal distribution (as described above) the digital personalized-market-share determination system 106 is able to sample coefficients γ, δ, and η with reduced convergence times (e.g., a reduced convergence time compared to drawing individual parameter values that are conditioned on all other parameters). For instance, by utilizing a block conditional (e.g., using multiple parameters in a block rather than at an individual level), the digital personalized-market-share determination system 106 is able to reduce convergence times and, therefore, computational time. Indeed, by utilizing block conditioning and a multivariate normal distribution as described above, the digital personalized-market-share determination system 106 is able to accurately determine personalized market shares and/or interconversion times for individual users with incomplete data while causing the model to converge with increased speed (e.g., with less computational time and processing).

Additionally, the digital personalized-market-share determination system 106 can also determine a sample for covariance Ω (e.g., a covariance of a distribution from which ∈ᵢ is obtained). For instance, the digital personalized-market-share determination system 106 can determine (or obtain) current values of ∈ᵢ (e.g., to obtain a sample for covariance Ω) using the list of generated samples Θ (e.g., Θᵢ), the covariates matrix (e.g., Aᵢ), and the obtained (or generated) samples for coefficients γ, δ, and η. In particular, the digital personalized-market-share determination system 106 can determine current values of ∈ᵢ by using the difference between the list of generated samples Θ (e.g., Θᵢ) and the product of the covariates matrix (e.g., matrix A) and the obtained (or generated) samples for coefficients γ, δ, and η (e.g., matrix B).

For example, the digital personalized-market-share determination system 106 can determine a sample for covariance Ω by using the following: Xₑₚₛ=[Θᵢ−Θ̅ₗ, i=0 . . . n−1]. Furthermore, the digital personalized-market-share determination system 106 can determine a prior distribution of covariance Ω by using an Inverse Wishart distribution. For instance, the digital personalized-market-share determination system 106 can determine a prior distribution of covariance Ω using the following: P(Ω)˜W⁻¹(Ψ, ν). Moreover, the digital personalized-market-share determination system 106 can determine a conditional posterior distribution of covariance Ω using the following:

(Ω|Θ,η,γ,δ)˜W⁻¹(X+Ψ,n+ν) where X=XₑₚₛXₑₚₛ^{T}.

Additionally, the for likelihood per user function (e.g., gᵢ), the digital personalized-market-share determination system 106 can utilize aggregate share of wallet information, an assumption for SOWᵢ, and a normal distribution. For example, for the inclusion of g₃ in the likelihood per user function, the digital personalized-market-share determination system 106 can assume that SOWᵢ values follows the relation:

$$\frac{S O {W}_{i}}{1 - S O {W}_{i}} - \frac{{SOW}_{a g g}}{1 - S O {W}_{a g g}} ∼ Normal ( 0 , {σ}^{2} ) .$$

In one or more embodiments, the digital personalized-market-share determination system 106 represents SOW_{agg} as aggregate share of wallet information. For instance, the digital personalized-market-share determination system 106 can generate and/or obtain aggregate share of wallet information (SOW_{agg}). In some embodiments, the digital personalized-market-share determination system 106 obtains aggregate share of wallet information from market reports (e.g., from a third party and/or market reports generated by the digital personalized-market-share determination system 106 and/or digital analytics system 104).

Furthermore, the digital personalized-market-share determination system 106 can obtain a sample of σ². For instance, the digital personalized-market-share determination system 106 can obtain a sample of σ² using Inverse Gamma (e.g., an inverse Gamma distribution). In particular, the digital personalized-market-share determination system 106 can obtain a prior for σ² using the following: Prior for σ²: Inverse Gamma(α, β). Moreover, the digital personalized-market-share determination system 106 can obtain a sample of σ² by using a conditional posterior for σ² using the following:

$$Inverse Gamma ( α + \frac{n}{2} , β + \frac{{\sum }_{i = 1}^{n} {( \frac{{SOW}_{i}}{1 - {SOW}_{i}} - \frac{{SOW}_{agg}}{1 - {SOW}_{agg}} )}^{2}}{2} ) .$$

As mentioned above, the digital personalized-market-share determination system 106 utilizes the Bayesian method and the MCMC method (described above) to estimate the scaling parameter (βᵢ) and conversion probabilities (λᵢ and ϕᵢ) for a user i based on a dataset of observable conversions. Then, the digital personalized-market-share determination system 106 can utilize the estimate scaling parameter (βᵢ) and conversion probabilities (λᵢ and ϕᵢ) to determine a personalized market share and/or an interconversion time for an individual user between a company and competitors of the company. For instance, as described above, the digital personalized-market-share determination system 106 can determine a personalized market share for the individual user by using the function:

$${SOW}_{i} = \frac{{λ}_{i}}{1 + {λ}_{i} - {φ}_{i}} .$$

Moreover, as an example and as described above, the digital personalized-market-share determination system 106 can determine an interconversion time for the individual user by using the function:

$$( \frac{2}{{β}_{i}} ) ( \frac{{λ}_{i} + ( 1 - {φ}_{i} )}{{λ}_{i}} ) .$$

Indeed, using the approach described above, the digital personalized-market-share determination system 106 can determine a personalized market share for an individual user within a specific product category based on observable conversions from clickstream data of a company. In some embodiments, as mentioned above, the digital personalized-market-share determination system 106 can determine a personalized market share for an individual user using only clickstream data available to a company (e.g., without using user interaction data from competitors of the company). Additionally, the digital personalized-market-share determination system 106 can utilize the one or more approaches described above to determine a variety of metrics (as the personalized market share). For instance, the digital personalized-market-share determination system 106 can determine a user's engagement (e.g., in terms of a percentage), spend (e.g., in terms of money), mind-share, and/or time corresponding to a company (e.g., a focal company) versus competitors of the company.

Moreover, the digital personalized-market-share determination system 106 can also determine an interconversion time for an individual user within a specific product category using the one or more approaches described above. In one or more embodiments, as mentioned above, the digital personalized-market-share determination system 106 can determine an interconversion time for an individual user using only clickstream data available to a company (e.g., without using user interaction data from competitors of the company). Furthermore, the digital personalized-market-share determination system 106 can utilize a determined personalized market share and/or interconversion time to determine a recency and/or frequency of an individual user in relation to the company versus competitors of the company.

Indeed, the digital personalized-market-share determination system 106 can utilize the one or more approaches described above, for various combinations of product categories. For example, the digital personalized-market-share determination system 106 can utilize observed purchases within a specific product category to determine a personalized market share and/or interconversion time for the specific product category. Moreover, the digital personalized-market-share determination system 106 can utilize the one or more approaches above to determine separate personalized market shares and/or interconversion times for individual users within different product categories.

Additionally, the digital personalized-market-share determination system 106 can utilize different distribution models for various portions of the approach described above. For instance, the digital personalized-market-share determination system 106 can utilize varying types of Gamma distributions (e.g., based on an input shape parameter) for the interconversion time distribution model. Moreover, the digital personalized-market-share determination system 106 can utilize a variety of other distributions and/or aggregate level market share reports/values for estimating conversion probabilities and/or scaling parameters to determine a personalized market share and/or interconversion time. In some embodiments, the digital personalized-market-share determination system 106 can receive input for selections of a variety of distribution models and/or values to utilize in various portions of the approach (e.g., as meta-intelligent input that can affect the resulting personalized market shares and/interconversion time values).

Moreover, in one or more embodiments, the digital personalized-market-share determination system 106 can evaluate the accuracy of a determined interconversion time. In particular, the digital personalized-market-share determination system 106 can observe an actual interconversion time (e.g., product category level interconversion time) for a user from data of a company (e.g., the focal company). Then, the digital personalized-market-share determination system 106 can compare the determined interconversion time (e.g., the estimated product category level interconversion time) to the observed, actual interconversion time to determine a distance (or closeness). For instance, the digital personalized-market-share determination system 106 can compare the distribution of the estimated interconversion times to observed, actual interconversion time distribution (e.g., a distribution represented as a histogram. In some embodiments, the digital personalized-market-share determination system 106 determines a distance between and/or an accuracy of the estimated interconversion time distribution (e.g., of all users) to an observed, actual interconversion time distribution using a median of the distributions, a mean absolute percentage error (MAPE), and/or Kolmogorov-Smirnov test (KS statistic or test).

As mentioned above, the digital personalized-market-share determination system 106 can generate graphical user interfaces to display personalized customer statistics for an individual user based on personalized market shares (and/or interconversion times) determined using clickstream data. In particular, the digital personalized-market-share determination system 106 can generate graphical user interfaces as analytics tools based on the determined personalized market shares (and/or interconversion times). In one or more embodiments, the digital personalized-market-share determination system 106 generate graphical user interfaces that provide personalized customer statistics such as trends, results, and/or target strategies for users (at an individual level) based on the personalized market shares (and/or interconversion times) determined using clickstream data.

For example, the digital personalized-market-share determination system 106 can generate graphical user interfaces to provide (or display) one or more trends for individual users based on clickstream data as personalized customer statistics. In particular, the digital personalized-market-share determination system 106 can utilize a personalized market share (e.g., in terms of engagement, spend, mind-share, and/or time of a user between a company and competitors of a company) to display a change in market share of an individual user over a duration of time. For instance, the digital personalized-market-share determination system 106 can generate a graphical user interface that displays changes in personalized market share (e.g., share of wallet value at an individual user level) at a company versus that of competitor companies.

As an example, FIG. 5A illustrates a graphical user interface generated by the digital personalized-market-share determination system 106 to display individualized customer statistics such as trends based on personalized market shares. For instance, as shown in FIG. 5A, the digital personalized-market-share determination system 106 can generate a graphical user interface 500 that displays a change (e.g., trend) in a determined personalized market share for an individual user (e.g., at a company versus competitors of the company). For example, as illustrated in FIG. 5A, the digital personalized-market-share determination system 106 displays a trend line 502 (e.g., for customer 2) that displays a personalized market share for an individual user (e.g., in terms of percent) across multiple months. Indeed, as shown in FIG. 5A, the digital personalized-market-share determination system 106 can display trend lines for multiple users by determining personalized market shares for each user (e.g., for each month).

In one or more embodiments, the digital personalized-market-share determination system 106 provides meaningful user metrics that demonstrate which individual users to focus on for marketing by displaying trend lines based on the determined personalized market shares of individual users. For instance, a digital personalized-market-share determination system 106 can determine that a user is losing interest in a company when a trend line demonstrates that there is a decline in a personalized market share corresponding to an individual user for the company. Indeed, the digital personalized-market-share determination system 106 can provide such information (to an administrator) in a graphical user interface to enable an administrator to focus on individual users that are losing interest (or share of wallet) with the company.

Furthermore, as shown in FIG. 5A, the digital personalized-market-share determination system 106 can generate the graphical user interface 500 to provide selectable option 504 to select a product category, a selectable option 506 to select a personalized customer statistic metric type, a selectable option 508 to select a user, and a selectable option 510 to select a data range. Indeed, the digital personalized-market-share determination system 106, can generate a graphical user interface based on receiving various combinations of selections for the one or more selectable options.

For example, the digital personalized-market-share determination system 106 can display personalized customer statistics (e.g., personalized market share trends of one or more users) for a specific product category that is selected using the selectable option 504 (as illustrated in FIG. 5A). Furthermore, as shown in FIG. 5A, the digital personalized-market-share determination system 106 can display different types of personalized customer statistics (e.g., personalized market share trends, interconversion time trends, target user information) for one or more users in response to a selection corresponding to the selectable option 506. Additionally, as illustrated in FIG. 5A, the digital personalized-market-share determination system 106 can display personalized customer statistics for one or more specific users (or all users) in response to a selection corresponding to the selectable option 508. Moreover, the digital personalized-market-share determination system 106, as shown in FIG. 5A, the digital personalized-market-share determination system 106 can also display personalized customer statistics for one or more users across various date ranges in response to a selection corresponding to the selectable option 510.

Additionally, the digital personalized-market-share determination system 106 can generate a graphical user interface with selectable options to quickly and efficiently provide a variety of personalized customer statistics and/or other user information. For instance, FIG. 5B illustrates the digital personalized-market-share determination system 106 providing personalized customer statistics and/or other user information based on a user interaction with the graphical user interface 500. Specifically, as shown in FIG. 5B, the digital personalized-market-share determination system 106 can receive a user interaction 512 with the trend line 502 associated with a user (e.g., a cursor hover, a touch screen selection, and/or a cursor selection). Moreover, as shown in FIG. 5B, in response to the user interaction 512, the digital personalized-market-share determination system 106 can provide additional personalized customer statistics for the selected user in a display interface 514 (e.g., a popup display). As shown in FIG. 5B, the digital personalized-market-share determination system 106 can provide information such as, but not limited to, a market share value for a specific month (e.g., based on the position of the user interaction), a competitor market share, and an interconversion time for the specific user. Furthermore, the digital personalized-market-share determination system 106 can provide such information in response to a user interaction with a displayed trend line for any user.

Moreover, the digital personalized-market-share determination system 106 can also generate a graphical user interface to provide a personalized customer journey (of observable conversions) for an individual user. For example, as shown in FIG. 5C, upon receiving a selection of a trend line or a user from a graphical user interface (e.g., as described in FIGS. 5A and 5B), the digital personalized-market-share determination system 106 can generate a graphical user interface 516 which includes a customer journey of observable conversions 518 for the selected user. Additionally, as illustrated in FIG. 5C, the digital personalized-market-share determination system 106 can display personalized customer statistics 520 within the graphical user interface 516. In addition, the digital personalized-market-share determination system 106 can also provide a selectable option 522 within the graphical user interface 516 to select a date range for the customer journey data and the personalized customer statistics data. Indeed, the digital personalized-market-share determination system 106 can provide any variety of selectable options as described above to modify the customer journey data and the personalized customer statistics data displayed for the individual user in the graphical user interface 516.

In some embodiments, the digital personalized-market-share determination system 106 can generate a graphical user interface to display personalized customer statistics such as personalized market share trends and/or interconversion time trends as inferential results based on input data. For example, the digital personalized-market-share determination system 106 can receive input data such as, but not limited to, price changes, changes in product variety, changes in operation (e.g., provided by an administrator) and input data such as possible reactions from competitors (e.g., price changes of a competitor, changes in product variety of a competitor, changes in operation of a competitor) to determine a personalized market share and/or interconversion time change for an individual user in accordance with one or more embodiments herein. Indeed, the digital personalized-market-share determination system 106 can provide a resulting (e.g., an inferential) personalized market share and/or interconversion time for one or more individual users by utilizing such input data with one or more approaches described above. For example, the digital personalized-market-share determination system 106 can generate a graphical user interface to provide such results and/or update such results upon receiving further input data or changes in input data (e.g., from an administrator).

Furthermore, the digital personalized-market-share determination system 106 can generate graphical user interfaces to identify target users based on personalized market share and/or interconversion time information determined using clickstream data. In particular, the digital personalized-market-share determination system 106 can determine an individual user that a company can target (e.g., as a potential opportunity and/or lead) using personalized market share and/or interconversion time information. Then, the digital personalized-market-share determination system 106 can identify (or indicate) within a graphical user interface the individual user (e.g., the target user).

For instance, in one or more embodiments, the digital personalized-market-share determination system 106 can identify a segment of users to target. For instance, the digital personalized-market-share determination system 106 can identify a target user based on a comparison between a personalized market share of the user and a threshold market share value (e.g., a value determined by an administrator). For example, the digital personalized-market-share determination system 106 can determine if the personalized market share of the user meets (is less than or equal to) the threshold market share value to identify the user as a target user. In particular, as an example, if a user is determined to have a small personalized market share compared to a market share of competitor companies, the digital personalized-market-share determination system 106 can indicate the user as a target user (e.g., such that a company directs efforts to increase the personalized market share of the user). Indeed, the digital personalized-market-share determination system 106 can identify multiple users that have personalized market shares that meet the threshold market share value as target users.

In some embodiments, the digital personalized-market-share determination system 106 can a target user based on a personalized market share and an interconversion time of the user. For instance, the digital personalized-market-share determination system 106 can compare a personalized market share of the user with a threshold market share value (e.g., a value determined by an administrator) and also compare an interconversion time of the user to a threshold interconversion time value. In particular, in some embodiments, the digital personalized-market-share determination system 106 can if the interconversion time of the user meets (is less than or equal to) the threshold interconversion time value to identify the user as a target user (in addition to comparing the personalized market share as described above). Indeed, as an example, if a user is determined to have a small personalized market share compared to a market share of competitor companies and a low interconversion time (e.g., purchases frequently), the digital personalized-market-share determination system 106 can indicate the user as a target user.

Moreover, upon identifying one or more target users (e.g., a segment of target users), the digital personalized-market-share determination system 106 can generate a graphical user interface to display the users as target users. For example, as shown in FIG. 6A, the digital personalized-market-share determination system 106 can generate a graphical user interface 600 to display personalized customer statistics for multiple users (as described in FIGS. 5A, 5B, and 5C). Moreover, as illustrated in FIG. 6A, the digital personalized-market-share determination system 106 can display an interface element 602 to indicate a specific user as a target user within the graphical user interface 600.

Furthermore, as shown in FIG. 6B, the digital personalized-market-share determination system 106 can display one or more target users in response to a display command to display target users from a selectable option. For instance, as illustrated in FIG. 6B, the digital personalized-market-share determination system 106 can display a selectable option 610 to highlight all target users in the graphical user interface 600. Indeed, as shown in FIG. 6B, the digital personalized-market-share determination system 106 can highlight trend lines corresponding to target users (e.g., trend lines 604 and 606) upon receiving a selection of the selectable option 610. Moreover, as also shown in FIG. 6B, the digital personalized-market-share determination system 106 can fade trend lines 608 corresponding to users that are not determined to be target users upon receiving a selection of the selectable option 610. Indeed, as shown in FIG. 6B, the digital personalized-market-share determination system 106 can enable an administrator to easily visualize target users versus non-target users based on the selectable option 610.

Additionally, in some embodiments, the digital personalized-market-share determination system 106 provides additional functionalities upon identifying a target user. For instance, the digital personalized-market-share determination system 106 can provide alerts to an administrator of the company which includes information for target users. In one or more embodiments, the digital personalized-market-share determination system 106 can also provide options (or functionalities) in relation to the identified target users.

For instance, the digital personalized-market-share determination system 106 can provide tools and/or options to easily increase and/or reduce marketing spend for a target user (and/or for users that are not identified as target users). Moreover, the digital personalized-market-share determination system 106 can also enable other functionalities such as, but not limited to providing tools and/or options to increase and/or decrease communications (e.g., emails and/or phone calls with a target user), marketing resources, promotions, and/or data storage for target users (and/or for users that are not identified as target users). Indeed, the digital personalized-market-share determination system 106 can enable a company to utilize such functionalities and/or personalized customer statistics to reduce churn of individual users and/or increase the ability to gain market shares for individual users.

Although one or more embodiments herein describe the digital personalized-market-share determination system 106 in regard to conversion interactions and product categories, the digital personalized-market-share determination system 106 can determine personalized market shares (and/or interconversion times) using clickstream data and provide graphical user interfaces based on such data for various use cases. For instance, the digital personalized-market-share determination system 106 can utilize clickstream data related to subscriptions (digital magazines, newspaper) and/or services (e.g., media streaming services, software services, cloud-based services). In particular, the digital personalized-market-share determination system 106 can determine a personalized market share (and/or other information) for a company providing such subscriptions and/or services and competitors of the company in accordance with one or more embodiments herein. Moreover, the digital personalized-market-share determination system 106 can also generate one or more graphical user interfaces to display such information and/or provide functionalities as described above for such subscription and/or service based use cases.

Experimenters utilized clickstream data spanning over four months and belonging to a focal company to determine personalized market shares of individual users for the focal company using the digital personalized-market-share determination system 106. In particular, the experimenters used the digital personalized-market-share determination system 106 to determine a personalized market share for spend (e.g., share of wallet) for users of the company based on clickstream data. In the experiment, three different product categories (video games, movies, and a catch-all (or overarching) category of six categories with similar purchase cycles) were utilized for the experiment. Indeed, the digital personalized-market-share determination system 106 determined personalized market shares and interconversion times for individual users within each category during the experiment.

Moreover, the experimenters utilized the digital personalized-market-share determination system 106 to evaluate the accuracy of the experimental values (e.g., the personalized market shares and interconversion times determined by the digital personalized-market-share determination system 106). Indeed, during the experiment, a comparison of the determined interconversion times for users to actual interconversion times in the above mentioned categories resulted in similar values for median interconversion times. Additionally, across the three categories, the MAPE values ranged between 11.4% and 12.6% with reasonable KS statistic distances between the determined distributions and the actual distributions of the interconversion times (e.g., which indicates that the digital personalized-market-share determination system 106 determines accurate values). For example, Table 1 (below) illustrates these results between the determined interconversion times and actual interconversion times for the three categories.

TABLE 1

| | Six | | |
|---|---|---|---|
| | Categories | Video Games | Movies |
| Observed Median ICT (Days) | 8.850 | 9.667 | 9.267 |
| Calculated Median ICT (Days) | 7.958 | 8.654 | 8.273 |
| MAPE | 11.83% | 11.37% | 12.60% |
| KS Statistics | 0.146 | 0.124 | 0.155 |

Additionally, experimenters demonstrated the sensitivity of the one or more models utilized by the digital personalized-market-share determination system 106 across category types, assumptions about the shape parameter of the interconversion time distribution, and the aggregate level market share data utilized (e.g., the shape parameter and aggregate level market share are obtainable from third party sources as meta-intelligent input). Indeed, the digital personalized-market-share determination system 106 determined personalized market share and interconversion time distributions for users with different distributions per category (e.g., the three experimental categories). Moreover, the digital personalized-market-share determination system 106 also determined interconversion times with small amounts of variance in distributions based on different aggregate share of wallet values (e.g., utilizing an aggregate level market share value of 0.1 and 0.03). Additionally, the digital personalized-market-share determination system 106 also determined a variance in personalized market share value distribution between using an Erlang-2 and an Erlang-5 distribution for the interconversion time distribution. Indeed, the resulting personalized market share distributions showed notable variance across the Erlang-2 and Erlang-5 distributions.

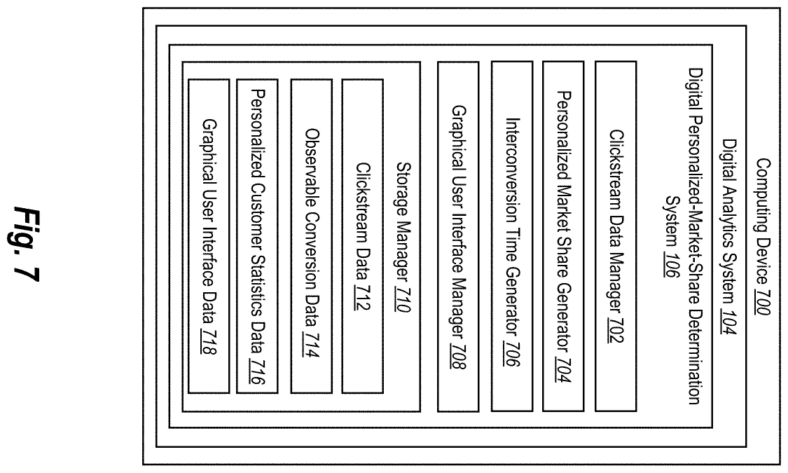

Turning now to FIG. 7, additional detail will be provided regarding components and capabilities of one or more embodiments of the digital personalized-market-share determination system. In particular, FIG. 7 illustrates an embodiment of an example digital personalized-market-share determination system 106 executed by a computing device 700 (e.g., the server device(s) 102, client device 110, and/or the client device 114). As shown by the embodiment in FIG. 7, the computing device 700 can include or host the digital analytics system 104 and the digital personalized-market-share determination system 106. The digital personalized-market-share determination system 106 can include a clickstream data manager 702, a personalized market share generator 704, an interconversion time generator 706, a graphical user interface manager 708, and a storage manager 710 which includes clickstream data 712, observable conversion data 714, personalized customer statistics data 716, and graphical user interface data 718.

As just mentioned, and as illustrated in the embodiment in FIG. 7, the digital personalized-market-share determination system 106 can include the clickstream data manager 702. For example, the clickstream data manager 702 can utilize clickstream data to map conversion interactions to product categories as described above (e.g., in relation to FIG. 3). Furthermore, the clickstream data manager 702 can utilize mappings of product categories to generate datasets of observable conversions for individual users across various product categories as described above (e.g., in relation to FIG. 3).

Additionally, as shown in FIG. 7, the digital personalized-market-share determination system 106 can include the personalized market share generator 704. For instance, the personalized market share generator 704 can utilize clickstream data (e.g., datasets of observable conversions from clickstream data) to determine a personalized market share for an individual user as described above (e.g., in relation to FIGS. 4A and 4B). In particular, the personalized market share generator 704 can determine a personalized market share for an individual user within a product category (between a company and competitors of a company) without utilizing user interaction data corresponding to a competitor as described above (e.g., in relation to FIGS. 4A and 4B).

In addition, as shown in FIG. 7, the digital personalized-market-share determination system 106 can include the interconversion time generator 706. For example, the interconversion time generator 706 can utilize clickstream data (e.g., datasets of observable conversions from clickstream data) to determine an interconversion time for an individual user as described above (e.g., in relation to FIGS. 4A and 4B). Moreover, the interconversion time generator 706 can determine an interconversion time for an individual user within a product category (across a company and competitors of a company) without utilizing user interaction data corresponding to a competitor as described above (e.g., in relation to FIGS. 4A and 4B).

Additionally, as illustrated in FIG. 7, the digital personalized-market-share determination system 106 can include the graphical user interface manager 708. For instance, the graphical user interface manager 708 can display personalized customer statistics for individual users based on determined personalized market shares and/or interconversion times as described above (e.g., in relation to FIGS. 5A, 5B, 5C, 6A, and 6B). Furthermore, the graphical user interface manager 708 can provide selectable options within graphical user interfaces to enable functionalities corresponding to personalized customer statistics based on determined personalized market shares and/or interconversion times of individual users as described above (e.g., in relation to FIGS. 5A, 5B, 5C, 6A, and 6B).

Moreover, as illustrated in FIG. 7, the digital personalized-market-share determination system 106 can include the storage manager 710. In some embodiments, the storage manager 710 can be implemented by one or more memory devices. The storage manager 710 can maintain data to perform one or more functions of the digital personalized-market-share determination system 106. As shown in FIG. 7, the storage manager 710 can include the clickstream data 712 (e.g., conversion interactions and/or hit-level interactions of individual users), the observable conversion data 714 (e.g., datasets of observable conversions for individual users with product category mappings for the observable conversions), the personalized customer statistics data 716 (e.g., personalized market shares, interconversion times, trends for individual users and identified target users), and graphical user interface data 718 (e.g., selectable elements, graphs, charts corresponding to determined personalized market shares and/or interconversion times).

Each of the components 702-718 of the computing device 700 (e.g., the computing device 700 implementing the digital personalized-market-share determination system 106), as shown in FIG. 7, may be in communication with one another using any suitable communication technologies. It will be recognized that although components 702-718 of the computing device 700 (or computer device) are shown to be separate in FIG. 7, any of components 702-718 may be combined into fewer components, such as into a single facility or module, divided into more components, or configured into different components as may serve a particular embodiment.

The components 702-718 of the computing device 700 can comprise software, hardware, or both. For example, the components 702-718 can comprise one or more instructions stored on a computer-readable storage medium and executable by processors of one or more computing devices. When executed by the one or more processors, the computer-executable instructions of the digital personalized-market-share determination system 106 (e.g., via the computing device 700) can cause a client device and/or a server device to perform the methods described herein. Alternatively, the components 702-718 and their corresponding elements can comprise hardware, such as a special purpose processing device to perform a certain function or group of functions. Additionally, the components 702-718 can comprise a combination of computer-executable instructions and hardware.

Furthermore, the components 702-718 of the digital personalized-market-share determination system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 702-718 may be implemented as a stand-alone application, such as a desktop or mobile application. Furthermore, the components 702-718 may be implemented as one or more web-based applications hosted on a remote server. The components 702-718 may also be implemented in a suite of mobile device applications or “apps.” To illustrate, the components 702-718 may be implemented in an application, including but not limited to, ADOBE ANALYTICS, ADOBE AUDIENCE MANAGER, ADOBE CAMPAIGN, ADOBE EXPERIENCE MANAGER, and ADOBE TARGET. “ADOBE ANALYTICS,” “ADOBE AUDIENCE MANAGER,” “ADOBE CAMPAIGN,” “ADOBE EXPERIENCE MANAGER,” and “ADOBE TARGET” are either registered trademarks or trademarks of Adobe Inc. in the United States and/or other countries.

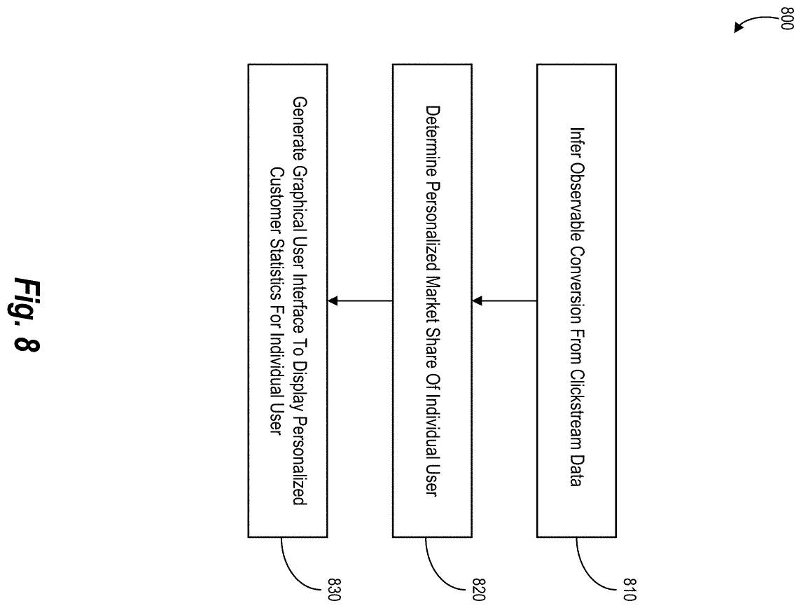

FIGS. 1-7, the corresponding text, and the examples provide a number of different methods, systems, devices, and non-transitory computer-readable media of the digital personalized-market-share determination system 106. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned above, FIG. 8 illustrates a flowchart of a series of acts 800 for determining a personalized market share of a user with a company versus that of its competitors using clickstream data in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As illustrated in FIG. 8, the series of acts 800 include an act 810 of inferring an observable conversion from clickstream data. In particular, the act 810 can include inferring one or more observable conversions within a product category from clickstream data corresponding to an individual user. For instance, clickstream data can be associated with a company. Additionally, the act 810 can include inferring one or more observable conversions within a product category by identifying a conversion interaction from clickstream data corresponding to an individual user and mapping the conversion interaction to the product category as an observable conversion using one or more hit-level interactions from the clickstream data prior to the conversion interaction. Moreover, the act 810 can include inferring one or more additional observable conversions within a product category from additional clickstream data corresponding to an additional user.

As illustrated in FIG. 8, the series of acts 800 include an act 820 of determining a personalized market share of an individual user. In particular, the act 820 can include determining a personalized market share of an individual user between a company and competitors of the company for a product category based on at least one or more observable conversions. Furthermore, the act 820 can include determining a personalized market share of an individual user between a company and competitors of the company for the product category without utilizing interaction data corresponding to the individual user from the competitors of the company. In addition, the act 820 can include determining an additional personalized market share of an additional user between a company and competitors of the company for a product category based on at least one or more additional observable conversions.

Moreover, the act 820 can include determining a personalized market share of an individual user between a company and competitors of the company for a product category by utilizing one or more estimate conversion probabilities for the individual user based on at least one or more observable conversions. Additionally, the act 820 can include determining one or more estimate conversion probabilities for an individual user using at least a multivariate normal distribution. Furthermore, the act 820 can include sampling one or more estimate conversion probabilities for an individual user using at least a multivariate normal distribution. In addition, the act 820 can include determining a personalized market share by utilizing one or more estimate conversion probabilities to calculate a share of wallet value corresponding to an individual user.

In addition to (or in the alternative to) the acts above, the digital personalized-market-share determination system 106 can also perform a step for determining a personalized market share of an individual user between a company and competitors of the company for a product category. For instance, the acts and algorithms described above in relation to FIGS. 4A and 4B (e.g., the acts 402 to 412) can comprise the corresponding acts and algorithms (i.e., structures) for performing a step for determining a personalized market share of an individual user between a company and competitors of the company for a product category.

Moreover, the act 820 can include determining an interconversion time value for an individual user across a company and competitors of the company for a product category based on at least one or more observable conversions. Additionally, the act 820 can include determining an interconversion time value for an individual user across a company and competitors of the company for a product category using a personalized market share of an individual user and an interconversion time model for the individual user. Furthermore, the act 820 can include determining an interconversion time value for an individual user across a company and competitors of the company for a product category without utilizing interaction data corresponding to the individual user from the competitors of the company.

In addition to (or in the alternative to) the acts above, the digital personalized-market-share determination system 106 can also perform a step for determining an interconversion time value for an individual user across a company and competitors of the company for a product category. For instance, the acts and algorithms described above in relation to FIGS. 4A and 4B (e.g., the acts 402 to 412) can comprise the corresponding acts and algorithms (i.e., structures) for performing a step for determining an interconversion time value for an individual user across a company and competitors of the company for a product category.

As illustrated in FIG. 8, the series of acts 800 include an act 830 of generating a graphical user interface to display personalized customer statistics for an individual user. In particular, the act 830 can include generating a graphical user interface to display personalized customer statistics for an individual user based on a personalized market share (and/or an interconversion time value) determined using clickstream data. Additionally, the act 830 can include generating a graphical user interface to display personalized customer statistics for an individual user by displaying one or more observable conversions and a personalized market share determined using clickstream data. Furthermore, the act 830 can include generating a graphical user interface to display personalized customer statistics for an individual user by displaying one or more observable conversions, a personalized market share, and an interconversion time value determining using clickstream data.

Moreover, the act 830 can include generating a graphical user interface to display personalized customer statistics for an individual user (based on a personalized market share and/or an interconversion time value determined using clickstream data) and personalized customer statistics for an additional user based on an additional personalized market share (and/or an additional interconversion time value) determined using additional clickstream data. In addition, the act 830 can include generating a graphical user interface to display personalized market shares of one or more additional users and a personalized market share of an individual user determined using clickstream data. Furthermore, the act 830 can include displaying, upon detecting a selection of an individual user within a graphical user interface, a personalized market share and an interconversion time value of the individual user within the graphical user interface.

Additionally, the act 830 can include identifying a segment of users to target based on a comparison between personalized market shares determined using clickstream data and a threshold market share value. Furthermore, the act 830 can include generating a graphical user interface to display a segment of users as target users. Moreover, the act 830 can include identifying an individual user as a target user based on a personalized market share and an interconversion time value determined using clickstream data. Furthermore, the act 830 can include identifying an individual user as a target user based on a comparison between a personalized market share determined using clickstream data and a threshold market share value. In addition, the act 830 can include generating a graphical user interface to display personalized customer statistics for an individual user by displaying the individual user as a target user.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., computing device 700, server device(s) 102, client device 110, and client device 114). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause a computer device to:
infer one or more observable conversions within a product category from clickstream data corresponding to an individual user, wherein the clickstream data is associated with a company;
determine a personalized market share of the individual user between the company and competitors of the company for the product category based on at least the one or more observable conversions; and
generate a graphical user interface to display personalized customer statistics for the individual user based on the personalized market share determined using the clickstream data.

2. The non-transitory computer-readable medium of claim 1, further comprising instructions that, when executed by the at least one processor, cause the computing device to infer the one or more observable conversions by:
identifying a conversion interaction from the clickstream data corresponding to the individual user; and
mapping the conversion interaction to the product category as an observable conversion using one or more hit-level interactions from the clickstream data prior to the conversion interaction.

3. The non-transitory computer-readable medium of claim 1, further comprising instructions that, when executed by the at least one processor, cause the computing device to determine the personalized market share of the individual user between the company and the competitors of the company for the product category by utilizing one or more estimate conversion probabilities for the individual user based on at least the one or more observable conversions.

4. The non-transitory computer-readable medium of claim 3, further comprising instructions that, when executed by the at least one processor, cause the computing device to determine the one or more estimate conversion probabilities for the individual user using at least a multivariate normal distribution.

5. The non-transitory computer-readable medium of claim 1, further comprising instructions that, when executed by the at least one processor, cause the computing device to determine an interconversion time value for the individual user across the company and the competitors of the company for the product category based on at least the one or more observable conversions.

6. The non-transitory computer-readable medium of claim 5, further comprising instructions that, when executed by the at least one processor, cause the computing device to determine the interconversion time value for the individual user across the company and the competitors of the company for the product category using the personalized market share of the individual user and an interconversion time model for the individual user.

7. The non-transitory computer-readable medium of claim 1, further comprising instructions that, when executed by the at least one processor, cause the computing device to determine the personalized market share of the individual user between the company and the competitors of the company for the product category without utilizing interaction data corresponding to the individual user from the competitors of the company.

8. The non-transitory computer-readable medium of claim 1, further comprising instructions that, when executed by the at least one processor, cause the computing device to:
infer one or more additional observable conversions within the product category from additional clickstream data corresponding to an additional user;
determine an additional personalized market share of the additional user between the company and the competitors of the company for the product category based on at least the one or more additional observable conversions; and
generate the graphical user interface to display the personalized customer statistics for the individual user and personalized customer statistics for the additional user based on the additional personalized market share determined using the additional clickstream data.

9. The non-transitory computer-readable medium of claim 1, further comprising instructions that, when executed by the at least one processor, cause the computing device to:
identify a segment of users to target based on a comparison between personalized market shares determined using clickstream data and a threshold market share value; and
generate the graphical user interface to display the segment of users as target users.

10. The non-transitory computer-readable medium of claim 1, further comprising instructions that, when executed by the at least one processor, cause the computing device to generate the graphical user interface to display the personalized customer statistics for the individual user by displaying the one or more observable conversions and the personalized market share determined using the clickstream data.

11. A system comprising:
one or more memory devices comprising clickstream data corresponding to an individual user, wherein the clickstream data is associated with a company;
one or more server devices that cause the system to:
infer one or more observable conversions within a product category for the individual user by:
identifying a conversion interaction from the clickstream data corresponding to the individual user; and
mapping the conversion interaction to the product category as an observable conversion using one or more hit-level interactions from the clickstream data prior to the conversion interaction;
determine a personalized market share of the individual user between the company and competitors of the company for the product category by utilizing one or more estimate conversion probabilities for the individual user based on at least the one or more observable conversions;
determine an interconversion time value for the individual user across the company and the competitors of the company for the product category based on at least the one or more observable conversions; and
generate a graphical user interface to display personalized customer statistics for the individual user based on the personalized market share and the interconversion time value determined using the clickstream data.

12. The system of claim 11, wherein the one or more server devices cause the system to determine the interconversion time value for the individual user across the company and the competitors of the company for the product category using the personalized market share of the individual user and an interconversion time model for the individual user.

13. The system of claim 11, wherein the one or more server devices cause the system to:
determine the personalized market share of the individual user between the company and the competitors of the company for the product category without utilizing interaction data corresponding to the individual user from the competitors of the company; and
determine the interconversion time value for the individual user across the company and the competitors of the company for the product category without utilizing the interaction data corresponding to the individual user from the competitors of the company.

14. The system of claim 11, wherein the one or more server devices cause the system to determine the personalized market share of the individual user between the company and the competitors of the company for the product category by:
sampling the one or more estimate conversion probabilities for the individual user using at least a multivariate normal distribution; and
determining the personalized market share by utilizing the one or more estimate conversion probabilities to calculate a share of wallet value corresponding to the individual user.

15. The system of claim 11, wherein the one or more server devices cause the system to:
infer one or more additional observable conversions within the product category from additional clickstream data corresponding to an additional user;
determine an additional personalized market share of the additional user between the company and the competitors of the company for the product category based on at least the one or more additional observable conversions; and
generate the graphical user interface to display the personalized customer statistics for the individual user and personalized customer statistics for the additional user based on the additional personalized market share determined using the additional clickstream data.

16. The system of claim 11, wherein the one or more server devices cause the system to:
identify the individual user as a target user based on the personalized market share and the interconversion time value determined using the clickstream data; and
generate the graphical user interface to display the personalized customer statistics for the individual user by displaying the individual user as the target user.

17. The system of claim 11, wherein the one or more server devices cause the system to generate the graphical user interface to display the personalized customer statistics for the individual user by displaying the one or more observable conversions, the personalized market share, and the interconversion time value determined using the clickstream data.

18. A computer-implemented method comprising:
inferring one or more observable conversions within a product category from clickstream data corresponding to an individual user, wherein the clickstream data is associated with a company;
performing a step for determining a personalized market share of the individual user between the company and competitors of the company for the product category;
performing a step for determining an interconversion time value for the individual user across the company and the competitors of the company for the product category;
generating a graphical user interface to display personalized market shares of one or more additional users and the personalized market share of the individual user determined using the clickstream data; and
displaying, upon detecting a selection of the individual user within the graphical user interface, the personalized market share and the interconversion time value of the individual user within the graphical user interface.

19. The computer-implemented method of claim 18, wherein inferring the one or more observable conversions comprises:
identifying a conversion interaction from the clickstream data corresponding to the individual user; and
mapping the conversion interaction to the product category as an observable conversion using one or more hit-level interactions from the clickstream data prior to the conversion interaction.

20. The computer-implemented method of claim 18, further comprising:
identifying the individual user as a target user based on a comparison between the personalized market share determined using the clickstream data and a threshold market share value; and
displaying, the individual user as the target user within the graphical user interface.
